(19) United States
(12) Patent Application Publication
(10) Pub. No.: US 2013/0211805 A1
(43) Pub. Date: Aug. 15, 2013

(54) Distribution Wide Estimated Risk Scoring to Decrease the Probability of Covariate Imbalances Adversely Affecting Randomized Trial Outcomes

(71) Applicant: William J. DWYER, Merrimac, MA (US)

(72) Inventor: William J. DWYER, Merrimac, MA (US)

(21) Appl. No.: 13/768,598

(22) Filed: Feb. 15, 2013

Related U.S. Application Data
(60) Provisional application No. 61/599,134, filed on Feb. 15, 2012.

(51) Int. Cl. G06F 17/50

(52) U.S. Cl. CPC G06F 17/5009
USPC 703/6

(57) ABSTRACT

In certain situations, such as clinical trials, random or semi-random trials may be used to evaluate an outcome of interest. The outcome of such randomized trials may be affected by variables known as “covariates” which, individually or in combination, interact with the underlying subject matter under study. When designing such a trial, it may be important to select an appropriate randomization scheme so that covariates of interest are evenly distributed among test groups. The present application provides a scoring system to compare the effectiveness of randomization schemes in decreasing the probability that covariates of interest will be imbalanced. Furthermore, methods, mediums, and systems are described herein for choosing a randomization scheme in order to improve the quality and predictive value of a randomized study.

### RELATED APPLICATION

This application claims priority to U.S. Provisional Application No. 61/599,134, filed Feb. 15, 2012, entitled “Use of Distribution Wide Estimated Risk (DWyER) Score to Decrease the Probability of Covariate Imbalances Adversely Affecting Randomized Clinical Trial Outcomes,” the disclosure of which is incorporated herein by reference in its entirety.

### FIELD OF THE INVENTION

The present application generally relates to randomized studies, and more specifically to reducing a risk of imbalances in subject characteristics among trial groups in a randomized trial.

### BACKGROUND

A researcher may use a randomized study in order to better understand a particular outcome. Randomized studies, such as clinical trials, may study the effects of certain elements (independent variables) on the outcome (the dependent variable).

For example, assume that a researcher is studying the effects of a calcium supplement on bone density. The researcher might assign people to two trial groups: one group (the test group) receives the calcium supplement, and the other group (the control group) does not. After a certain amount of time, the researcher measures the bone density of each of the groups and makes comparisons between the groups. In this case, whether or not a particular subject receives the calcium supplement may be considered the independent variable, because the researcher was able to control for this variable and believes that it will be the primary determinant of the outcome (i.e., resulting bone density). The resulting bone density is considered the dependent variable, because the researcher believes that differences in the outcome (the resulting bone density) are determined primarily by the independent variable (whether the subject received the calcium supplement).

In addition to the independent and dependent variables noted above, other variables (such as the characteristics of individual subjects in the population under study) may affect the outcome of the trial. Some of these other variables may interact with each other in ways that are more significant than the effect of each variable individually. When secondary characteristics are not properly accounted for in the design of a trial, imbalances may be present among the trial groups. These imbalances may make researchers less confident that the outcome of the trial is an accurate reflection of the subject matter under study.

A brief summary of concepts relating to trial design and terminology is provided below.

### P-Values

Randomized trials result in data that is analyzed with the assistance of a “p-value.” In statistics, a p-value is a probability that particular statement (known as the “null hypothesis”) is true given the observed results.

For example, a statistical test may evaluate whether a particular coin is fair (i.e., yields heads and tails with an equal probability when flipped). The null hypothesis may be that the coin is fair. In an experiment to test the null hypothesis, the coin may be flipped 20 times. Assume that the coin lands “tails” up 15 times. The probability of such an event occurring, assuming that the coin is indeed fair, is 0.0414 (or 4.14%, given a binomial distribution of probabilities). This is the p-value of the experiment. The higher the p-value, the more confident the researcher can be that the null hypothesis is true.

In general, researchers assign a threshold (e.g., 5% or 10%) in order to determine whether the null hypothesis should be rejected. In the above experiment, a threshold of 5% may be assigned to evaluate the results of the experiment. In this case, the p-value of 4.14% is below this threshold, and accordingly the study suggests that we should reject the null hypothesis. That is, the research suggests that the coin is not fair.

In some situations, it may be that a researcher hopes to reject the null hypothesis, rather than accept the null hypothesis. For example, assume that a researcher conducts a study to test the efficacy of a particular drug, and produces a set of results. In this case, the null hypothesis might be that “the results of the study happened by chance” (i.e., the drug had no effect). In this case, if we hope to conclude that the drug may be effective, we must achieve a suitably low p-value in order to reject the null hypothesis and conclude that the drug is effective. For example, if the p-value determined from the results is 0.03, then we may conclude that there is only a 3% chance that the observed results were a matter of random chance, and therefore reject the null hypothesis and conclude that the drug may be effective.

### Randomization Schemes

One factor that can reduce a researcher's confidence in the results of a study is a lack of comparability between trial groups. For example, the subjects that participate in the study may have different ages, different weights, and different levels of physical activity, etc. Each of these variables may interact with the independent variable and/or dependent variable in order to affect the outcome or conclusions of the study.

Unequal distributions of patient characteristics that independently associate with the outcome of interest can cause a researcher to over- or under-estimate a treatment effect. For example, we might not consider the above-described bone density study a valid one if the control group consisted entirely of elderly people at increased risk for osteoporosis, while the test group consists entirely of students between the ages of 18 and 25. In this case, we might see no improvement or even a loss of bone density in the control group while the test group sees an increase or no change in bone density. This difference among trial groups may not be due to the use to the calcium supplement, but rather may be simply because of the underlying condition of the individuals in each trial group. If these conditions are not taken into account (e.g., by increasing the p-value of the results), the researcher might conclude (erroneously) that the calcium supplement had a greater effect on bone density than it actually did.

Researchers often attempt to create comparable trial groups by randomizing the study. There are a number of different ways that randomization can be done.

For instance, using the calcium supplement study above, we could simply flip a coin for each subject. If the coin comes up heads, the subject takes a placebo (i.e., the subject is placed in the “control” group). If the coin comes up tails, the subject receives the calcium supplement. (i.e., the subject is placed within the “test” group). This situation, in which each participant has an equal chance to be assigned to each trial group, is an example of “simple randomization.”

However, such coin flips may randomly assign an uneven distribution of subjects to one group or another. For example, 66% of people might end up (by chance) in the control group, leaving too few people in the test group to generate a reasonable prediction. Alternatively, even if the number of subjects is evenly distributed in each group, the characteristics of the groups may be different (e.g., too many elderly people are placed into the control or test group). Thus, a researcher may know, even before a study starts, that the results of the study will not be reliable because the test group and the control group are not comparable.

In order to avoid this situation, “stratified randomization” is sometimes used. In stratified randomization, the researcher selects secondary characteristics which the researcher believes will be of significance, and creates a series of subgroups, or strata, based on these characteristics. For example, the researcher may consider that age and weight will have an effect of the outcome of the study, and might therefore create four subgroups: (1) normal weight and under 65; (2) overweight and under 65; (3) normal weight and over 65; and (4) overweight and over 65. The study participants may be categorized based on these strata, and then randomization may be performed separately for each strata. For example, we might assign members of strata (1) to the control group or test group with probability ½, and then assign members of strata (2) to the control or test group with probability ½, and so on.

A stratified randomization scheme increases the chances that each strata is sufficiently represented within the control and trial groups. One downside to stratified randomization is that selecting the appropriate strata may be difficult, especially when the researcher does not have a strong basis for understanding what secondary characteristics may interact with the independent and dependent variables. Moreover, each stratum has its own probability of being imbalanced by chance, increasing the risk of subject imbalance being identified because there are now multiple strata to test.

A third example of a randomization scheme is dynamic random allocation. In dynamic random allocation, the probability of assigning a particular subject to a group within the study (e.g., control group or test group) changes depending on the characteristics of the subjects already assigned to the group. This is in contrast to simple randomization and stratified randomization, because in simple and stratified randomization, the probability of assigning a member to a group does not change as subjects are assigned to the groups.

For instance, consider the strata from the stratified randomization scheme above. In stratified randomization, subjects within each strata were assigned to the control group or the test group with a 50/50 probability. However, assume that we assign the first ten people in strata (1) (i.e., normal weight and under 65), and the result is that seven people are assigned to the control group and three people are assigned to the test group. We cannot simply start placing people from strata (1) into the test group to correct for this imbalance, because the study would no longer be randomized. However, under dynamic randomization, we can change the probability that the next subject from strata (1) will be assigned to the test group.

For example, we might assign the next subject from strata (1) to the test group with a probability of 0.60 (instead of 0.50). If the randomization scheme still places the subject into the control group, the probability may be increased again, according to a formula (perhaps to 0.65). This is sometimes referred to as “adaptive biased coin” randomization. This randomization scheme therefore attempts to maintain a balance between strata within trial groups.

Numerous other randomization schemes have been developed, many of which could be used to randomize a given trial.

A problem may arise in that, in randomizing subjects into groups, researchers have only a limited amount of “randomization capital” that can be allocated. Randomization capital refers to the choices that a researcher makes with respect to options for randomization (for example, the number of strata, the specific characteristics represented by each strata, whether certain strata are more important than others, etc.) that may affect the availability or extent of other randomization choices. By choosing some options, other options may be foreclosed, or their significance may be reduced.

For example, if a large number of strata are selected, it may be difficult to find a sufficient number of subjects in the study population with the characteristics that will allow for an even distribution of the characteristics represented by the strata throughout the trial groups. In another example, by choosing to weight one strata as more important than another, there are some situations in which the less-important strata may be effectively foreclosed from consideration, since most of the available randomization capital is spent on attempts to ensure that the more-important strata is well-represented in each group.

Accordingly, it is important, when designing randomized trials, to select an appropriate randomization strategy, and further to assign available randomization capital within the parameters of the randomization strategy in order to achieve a balance of characteristics of interest in the study population.

### SUMMARY

The present application provides a scoring system to compare the effectiveness of randomization schemes in reducing the probability that secondary characteristics (“covariates”) will be distributed throughout the subject population in an imbalanced manner. According to exemplary embodiments, mediums, methods, and systems are provided for quantifying a risk of covariate imbalances and/or selecting a randomization technique that reduces the risk of such a covariate imbalance.

In exemplary embodiments, characteristics of interest related to a population may be received by an electronic device. The characteristics of interest may include characteristics of interest that independently associate with an outcome of interest in a randomized trial. Input may further be provided regarding at least one of the population size, the number of trial sites, and the proportion of subjects at each site to be considered, scored, or tested.

Some subpopulations within the population may have multiple levels of risk for characteristics of interest associated with the population-level characteristics of interest.

Dependency information for such subpopulations may be provided and accounted for in determining a risk of covariate imbalances.

One or more randomization models may be presented for consideration, and a selection of one or more of the randomization models may be received. The one or more randomization models may be selected, for example, by a user through a user interface. Alternatively, the randomization schemes may be programmatically selected.

P-values for the characteristics of interest may be determined, based at least in part on the selected randomization schemes. For example, simulations may be carried out using the randomization scheme and the characteristics of interest, and p-values for the characteristics of interest may be calculated based on the simulation results.

Using the calculated p-values, a risk of covariate imbalance for each of the tested randomization models may be determined. The risk may be represented as a risk score. The risk may be calculated, for example, using a score that accounts for how well a randomization scheme allocates subjects within the population (that is, how well the randomization scheme allocates available randomization capital) in order to reduce the chance of an imbalance among study participant characteristics. In other words, the risk may be calculated to account for which randomization scheme is most likely to produce comparable groups.

Based on the calculated risks, one or more of the randomization models that is/are associated with a reduced risk of covariate imbalances may be identified. For example, the calculated risks may be displayed on a graph that compares the different randomization schemes. The calculated risks may be displayed on a display device.

Additionally, if information was provided regarding the population size, the number of trial sites, or the proportion of subjects at each site to be considered, scored, or tested, then a population size, number of trial sites, and/or proportion of subjects that is associated with a reduced risk of covariate imbalances may be identified.

Using the randomization model or models that have been identified as being associated with a reduced risk of covariate imbalances, a population may be selected for the trial. Accordingly, a researcher may use the calculated risk scores to allocate available randomization capital in the trial in order to reduce the risk of covariate imbalances for one or more characteristics represented in the trial.

A selection of a randomization model, a population size, and a number of sites may be received. This information may be packaged into a trial design for the population of interest. By applying the trial design during the trial, a researcher may efficiently randomize the subjects in the trial and reduce the risk of covariate imbalances for one or more characteristics relevant to the trial.

Other direct and theoretical trial costs may also be tracked, such as startup costs, study duration, and statistical power. This allows further refinement of the randomization model chosen when viewed as a cost alongside other trial costs, prompting the researcher to balance limited resources with probability of identifying a successful treatment. To clarify the trade-offs, cost estimates are entered for extending the trial past a set duration as well as for implementing the randomization model. For statistical errors, the user defines a cost for each percentage point increase in the risk of covariate imbalances. The researcher also enters a percentage point cost for the proportional risk of not detecting a significant treatment effect when one exists, the Type II error. Presenting the theoretical statistical risks of covariate imbalances and statistical power as costs provides additional information on the total cost of running the trial. This allows the researcher to make decisions on what is cost-effective.

Using the above information, a macro may be set up in which the software iterates through a range of parameters to find the most cost-effective trial design. To accomplish this, some or all possible site combinations may be tested. Alternatively, the time (enrollment rate) and site costs may be used to test the site having the lowest-cost per enrollee. Testing may then continue by adding sites that have the next highest cost per enrollee. A cohort-size range may be selected and iterated through by entering a minimum cohort size and a maximum cohort size, as well as an increment to be tested.

Exemplary embodiments may take the form of a computer-implemented method. Alternatively, some embodiments may take the form of a non-transitory computer-readable medium storing instructions that, when executed by one or more processors, cause the one or more processors to execute the instructions. Furthermore, exemplary embodiments may take the form of a system including a non-transitory medium and one or more processors.

### DESCRIPTION OF THE FIGURES

Throughout the application, reference will be made to the following Figures:

FIG. 1 is a flowchart depicting an exemplary method for reducing a risk of covariate imbalances in a randomized study.

FIG. 2A depicts population information that may be used to determine a risk of a covariate imbalance according to an exemplary embodiment.

FIGS. 2B-2I depict exemplary interfaces for providing population information according to exemplary embodiments.

FIGS. 3A-3E depict exemplary interfaces for providing information regarding randomization schemes according to exemplary embodiments.

FIG. 4A depicts an exemplary interface for providing information related to estimated risk scores for predicting the risk of a covariate imbalance.

FIG. 4B depicts an exemplary interface for providing information concerning study startup, duration, and review time as well as the direct costs associated with each. Theoretical costs, such as statistical power, may also be entered in the exemplary interface of FIG. 4B.

FIG. 4C depicts an exemplary interface for providing information regarding macro parameters for iterating through the number of sites and the cohort sizes to be simulated.

FIG. 5 depicts an exemplary summary interface summarizing information entered in FIGS. 2B-4.

FIG. 6 is an exemplary output graph showing the proportion of covariate P-values that are at or above a threshold level for significance for a particular covariate.

FIG. 7 is an exemplary output data table showing the proportion of covariate P-values that are at or above a threshold level for significance for a particular covariate.

FIG. 8A is an exemplary output graph showing the covariate P-values that are at or above a threshold level for significance among cohorts of different sizes subjected to a specified randomization scheme.

FIG. 8B is an exemplary output graph showing the covariate P-values that are at or above a threshold level for significance among cohorts subjected to a different randomization schemes.

FIG. 8C is an exemplary output plot showing a proportion of cohorts having P-values that are at or above a threshold as compared to the size of the cohorts for different randomization schemes.

FIG. 9 depicts an exemplary electronic computing device suitable for use with exemplary embodiments of the present invention.

FIG. 10 depicts an exemplary network implementation suitable for use with exemplary embodiments of the present invention.

### DETAILED DESCRIPTION

The present application provides a scoring system to compare the effectiveness of randomization schemes in decreasing the probability that covariates will be imbalanced. After receiving population-related information including a description of covariates present in the study population, different randomization models may be selected for testing. A risk of covariate imbalances may be determined for the models, based on p-values calculated for the covariates. The determined risks for each randomization model may be presented, and the determined risks may be used to evaluate which randomization models are associated with a reduced risk of a covariate imbalance.

A “covariate” is a variable which may be predictive, in whole or in part, of the outcome in question in a study or trial. Covariates may be secondary characteristics which may interact with a primary variable of interest. Examples of covariates include the age, weight, level of physical activity, and known diseases or conditions of the subject. Because covariates may play a significant role in determining the outcome of a randomized study, it may be important to control for them.

When groups or subgroups within a study are imbalanced based on these secondary characteristics, as in the above example, this may be referred to as a “covariate imbalance.” Having covariate imbalances in a study may reduce a researcher's confidence in the results of the study. Despite the use of randomization techniques designed to minimize the significance of covariate imbalances, such imbalances often remain in randomized trials.

For example, even if a randomization technique is used, an appropriate technique must still be selected from the numerous techniques available. If the “wrong” randomization scheme is selected, this may increase the chances that the randomized trial groups are not comparable to each other (and hence no conclusions can be drawn about the effectiveness of the treatment method or independent variable).

Another problem is the identification of covariates which may affect the outcome of the trial. Particularly when the subject matter of the trial has not been well-studied in the past, it may be difficult to know what covariates to consider when assigning subjects to randomization groups.

Conventionally, researchers may estimate a probability that a particular covariate may affect the outcome of the trial. In this situation, the researchers may establish a threshold, such as “if a particular covariate associates with the outcome of a trial with a p-value of more than 10%, the covariate will not be considered in trial design.”

However, some covariates which are not independently significant may become significant when paired with other covariates (which themselves may also not be independently significant). For example, assume that being over the age of 65 is associated with the outcome of the trial according to a p-value of only about 12%. Furthermore, assume that being a member of a particular gender is also associated with only a p-value of about 14%. Individually, these particular covariates may not rise to the level of significance, and hence may be excluded from consideration. Nonetheless, it may be the case that being a man over the age of 65 is associated with an increased chance of affecting the outcome of the study, and accordingly the combination of these covariates could rise to the level of significance (even though each covariate, considered independently, does not).

For these and other reasons, even with proper randomization techniques, randomized trials may remain susceptible to covariate imbalances that can call the results of the study into question.

In addition to increasing the likelihood of a successful trial in general, minimizing the risk of over- or understating treatments effects by managing important covariate subgroups may also increase the granularity of the trial. Granularity refers to the ability to determine the impact of the treatment on particular subgroups, where treatment effects might vary widely for individual subject covariates. Ultimately, the risk of misrepresenting the success or failure of a treatment overall and overlooking its applicability to individual subjects may add to the cost in developing a treatment. The risk of covariate imbalances may be balanced with other aspects of cost in trial design, including direct costs (e.g., study startup, duration, and review time as well as the costs associated with each) and theoretical costs (e.g., statistical risk of failing to enroll sufficient subjects to detect a meaningful difference between treatment and control, known as Type II error, or statistical power).

### Overview

Methods, mediums, and systems are described herein for choosing a randomization scheme in order to improve the quality and predictive value of a randomized study. In one embodiment, simulated cohorts (e.g., 1-1000 cohorts) of varying subject size (e.g., 10-10000 subjects) may be created. In each simulated cohort, each subject may have an individual profile of pertinent covariates of interest. Statistical tests may be run (based on, for example, sample size, normality, and type of variables considered) to determine a risk of a covariate imbalance based on particular randomization schemes.

A simulated population may be generated by specifying conditions (e.g., covariates) and the distribution of those conditions throughout the population. Other preferences, such as preferred size and/or number of cohorts into which the simulated population should be divided, may also be provided. Using the conditions, distribution, and preferences, a number of simulated subjects may be generated. Each simulated subject may have, for example, a covariate profile indicating the covariates with which the simulated subject is associated.

A variety of randomization schemes, which may include user-defined randomization schemes, may be selected for analysis. The randomization schemes may include, for example, simple designs (e.g., permutated block designs, Wei's Urn, etc.), stratified designs, complex designs (e.g., strata defined by groupings across characteristics, etc.), and hierarchical designs for which allocation occurs by prioritizing covariates in conjunction with randomization features of other randomization schemes.

Subjects from the simulated population may be randomized into cohorts based on the selected randomization scheme and/or the selected cohort size. Accordingly, each simulated cohort will include a number of simulated subjects having various covariates of interest distributed among them.

Using each cohort as a test of the randomization scheme and/or cohort size which was used to define the cohort, a risk score may be assigned to the cohort (and or/groups of cohorts having the same size and randomization scheme). The risk score may represent a probability that the randomization scheme/cohort size combination for a set of cohorts is at risk for a covariate imbalance—e.g., that the covariate imbalance may cause trial groups, when randomized using the randomization scheme and cohort size tested by the cohort, to be sufficiently imbalanced that the trial groups may not be directly comparable.

In order to calculate the risk score, one or more p-values (representing a significance of a particular covariate in affecting the independent variable or outcome of interest) may be determined for each cohort. The most significant (e.g., the smallest) p-value for each cohort may be chosen to represent the cohort. As noted above, multiple cohorts may be used to test each randomization scheme and/or cohort size. Accordingly, the p-values for the cohorts corresponding to a particular randomization scheme/cohort size may be grouped together, and the associated p-values may be sorted. The proportion of p-values falling below a certain threshold for significance for the randomization scheme/cohort size group may be used as the risk score for that particular randomization scheme/cohort size combination.

The scoring algorithms may accordingly assess the overall probabilistic risk that each of the selected randomization schemes fail to create comparable groups, as well as their efficiency in creating such comparable groups. The results may be displayed using tables and/or graphical output.

The randomization scheme/cohort size combination with the lowest score may be chosen to represent the randomization scheme/cohort size with the lowest risk (among those selected for consideration) of generating trial groups with a significant covariate imbalance.

Using the above-described techniques, a desired randomization scheme can be chosen before a randomized trial fails to clarify an outcome due to an ineffective randomization scheme, which conventionally may not be detected until after the trial is carried out.

### Exemplary Embodiments

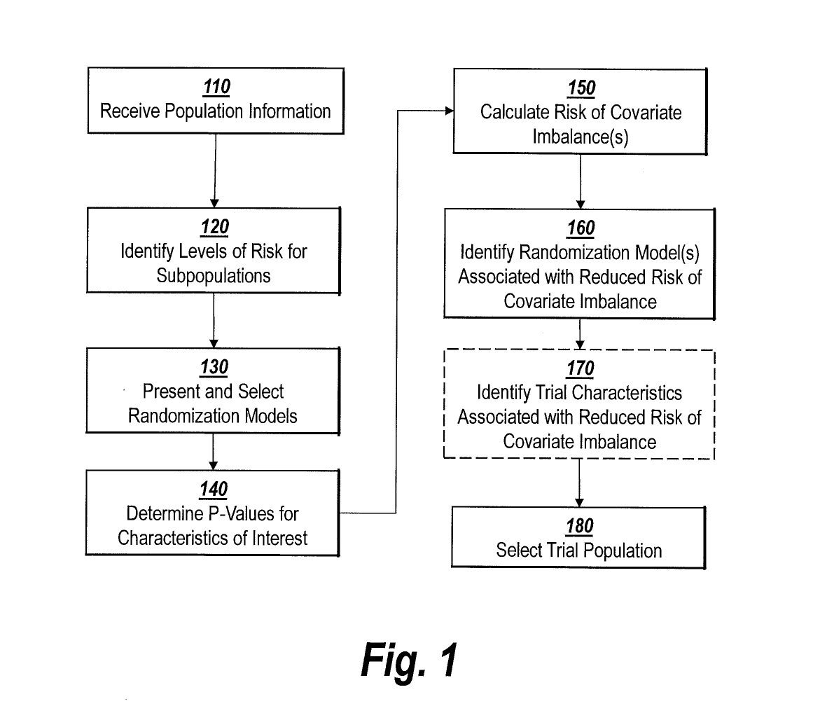

An exemplary method suitable for use in practicing the present invention is described with reference to the flowchart of FIG. 1.

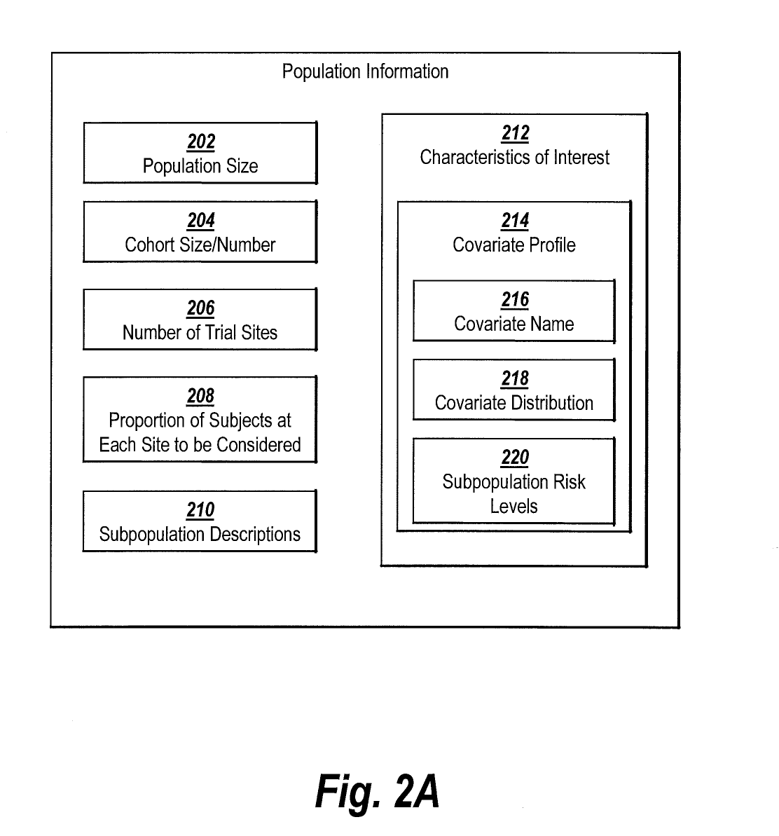

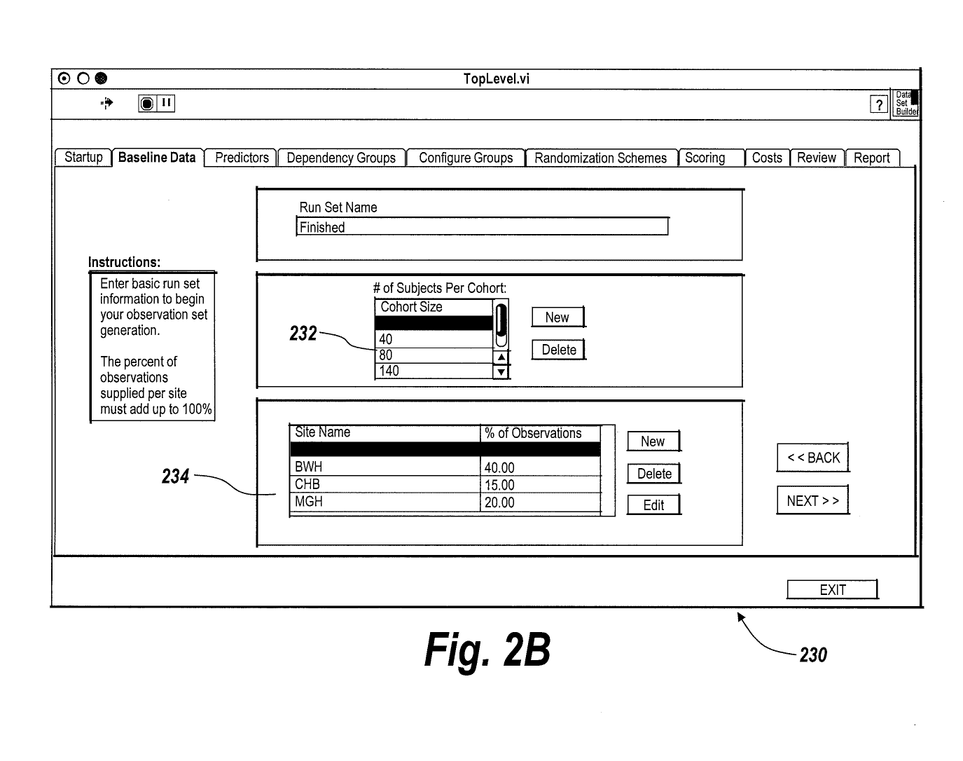

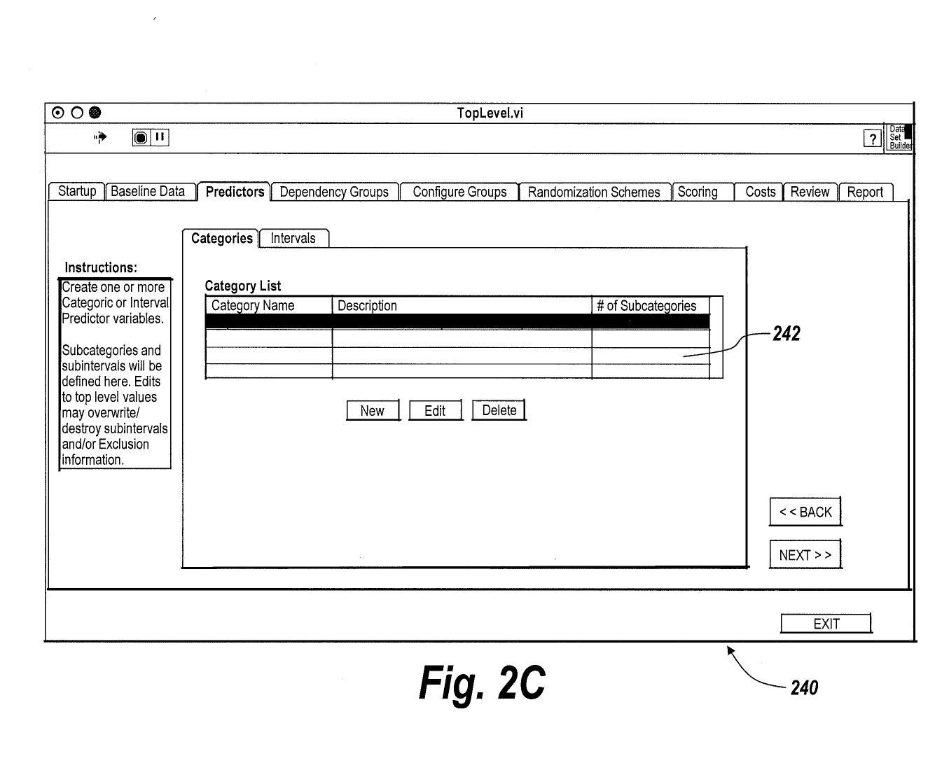

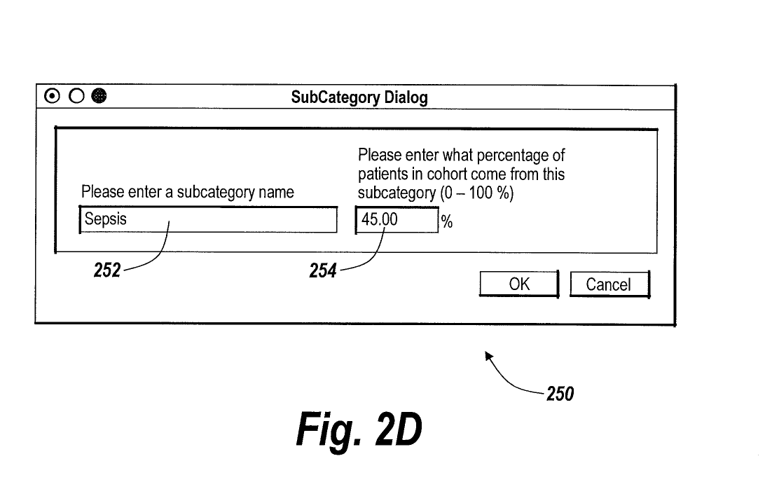

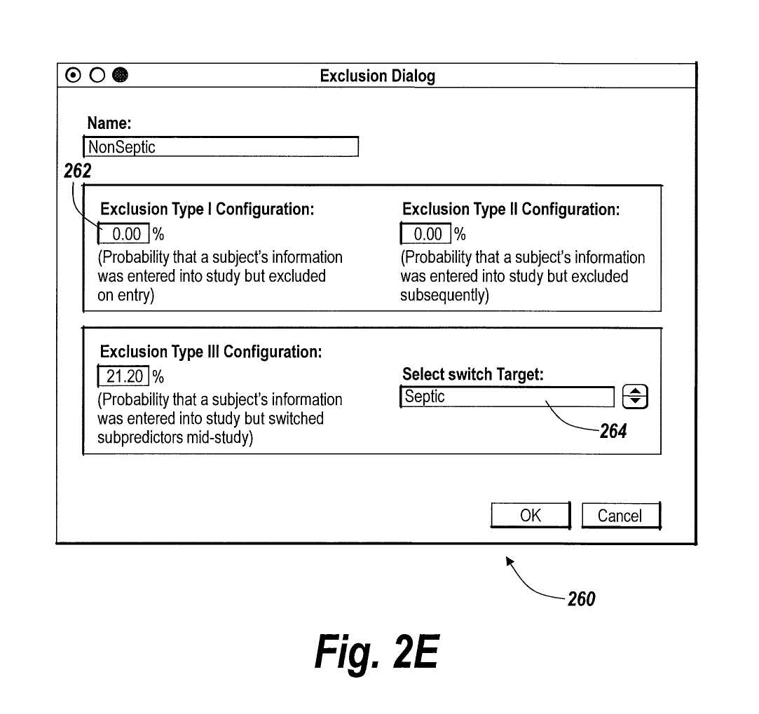

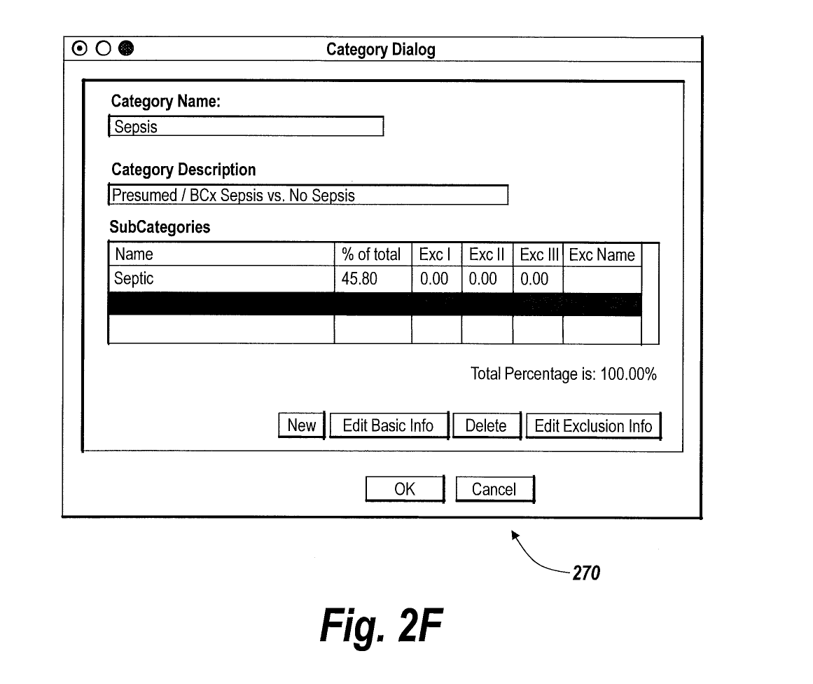

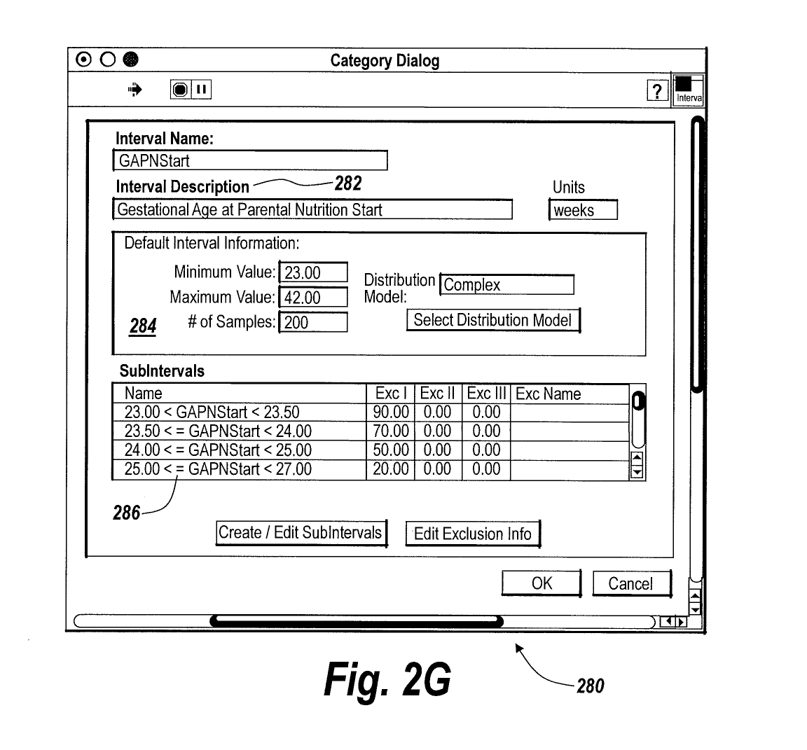

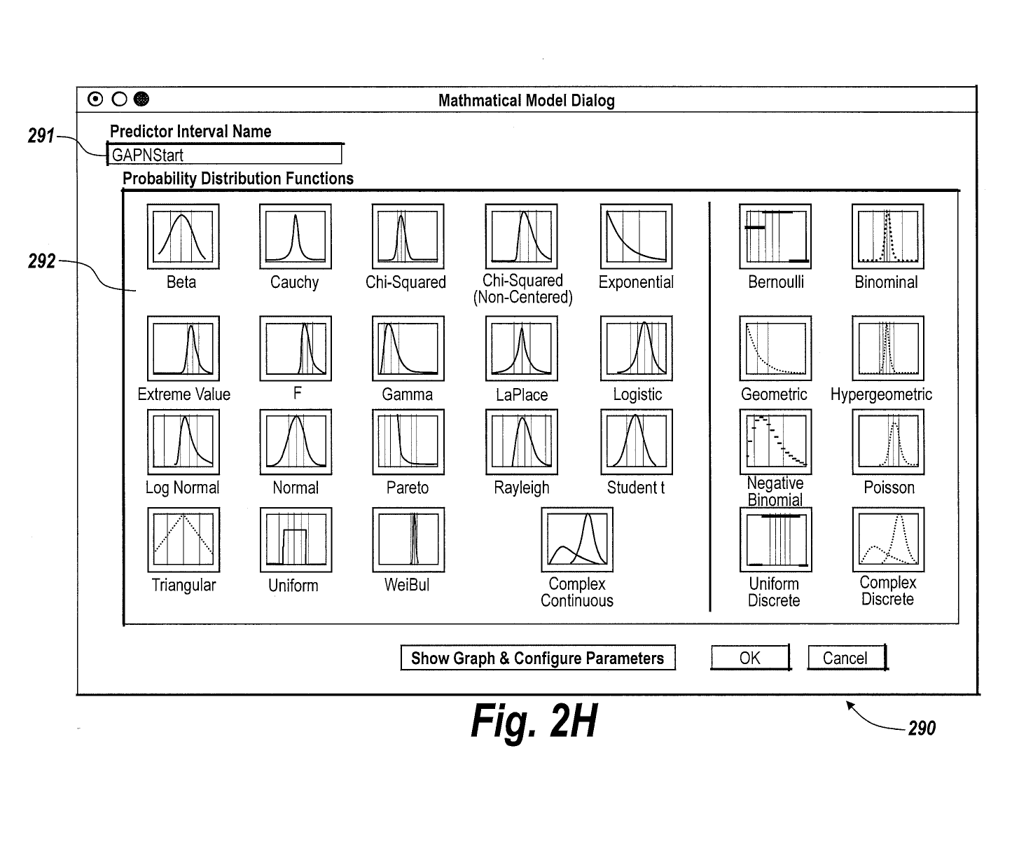

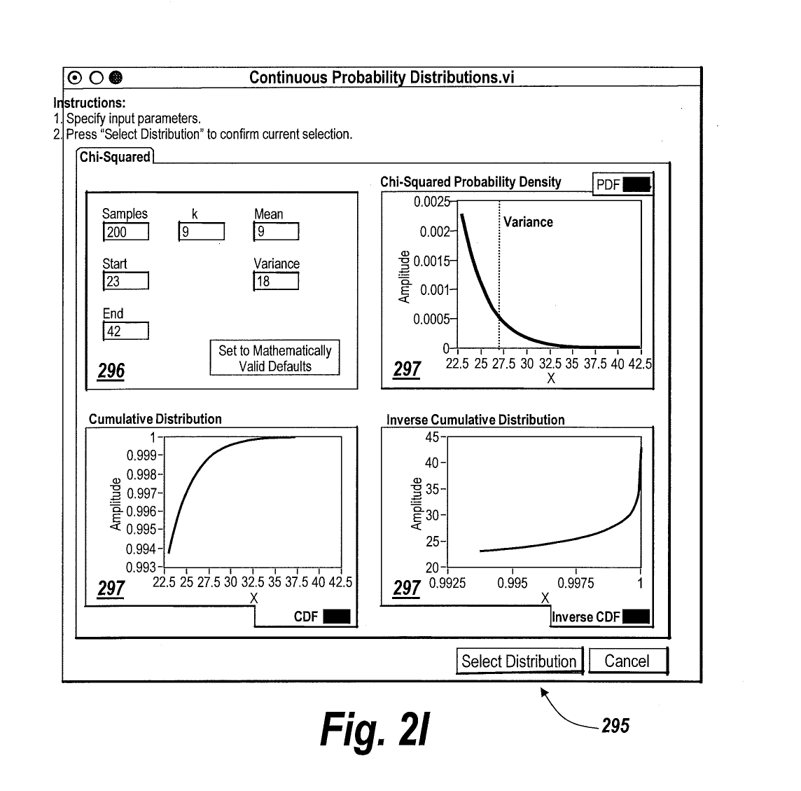

At step 110, information relating to the population under study may be received. As shown in FIG. 2A, the population information may include the population size 202. The population size 202 may represent the total number of individuals who are available for study, and from which randomized groups may be drawn. The study population may be divided into two or more cohorts. Accordingly, the population information may further include the number and/or size of the cohorts 204.

The study may be conducted at a variety of trial sites (e.g., multiple hospitals dispersed over a wide geographic area) The number of trial sites 206, and the proportion of subjects at each trial site who are considered in the study 208, may further be included in the population information.

The population may be divided into two or more subpopulations with varying characteristics of interest. Subpopulations may be defined, for example, based on one or more characteristics of the subjects (examples of such characteristics may include age, gender, race, etc.). Descriptions 210 of such subpopulations (e.g., the size and characteristics of the subpopulations) may be included in the population information.

A list 212 of one or more characteristics of interest in the population may be included in the population. For example, if the members of the population are associated with one or more covariates of interest, a covariate profile 214 may be prepared for the covariates. The covariate profile 214 may include a name 216 of the covariate, a distribution 218 of the covariate amongst members of the population or one or more subpopulations, and/or risk levels 220 for each subpopulation in having or contracting a conditions associated with the covariate of interest.

Multiple values may be provided and stored for each population information parameter. For example, if the researcher wishes to investigate the effect of differing cohort sizes on the risk of covariate imbalances in the study, the researcher may specify multiple cohort sizes/numbers 204 to be tested.

Returning again to FIG. 1, at step 120, risk levels for subpopulations may be identified. For one or more of the subgroups defined at step 110 and one or more of the covariates identified at step 110, the chances that a member of the subpopulation has a condition associated with the covariate may be identified. For example, if the population is broken into subpopulations by gender (e.g., a “male” subpopulation and a “female” subpopulation), and the covariate of interest is the incidence of lung cancer, then the risk level for the “male” subpopulation is approximately 0.07%, while the risk level for the “female” population is approximately 0.05% (based on 2008 statistics). Thus, the subpopulation may be broken into multiple risk levels.

If the presence of two or more of the covariates within a subpopulation are related to each other, then dependency information may be provided for the covariates. That is, if the probability of a first covariate being present in a subject or subpopulation is dependent on, or affected by, the presence of a second covariate, then the two covariates may be linked and dependency information (e.g., conditional probabilities for the presence of the covariates) may be provided. Furthermore, if two or more covariates are known to interact with each other to vary the probability of a particular condition, this information may be noted as well.

At step 130, one or more randomization models may be presented and selected. The randomization models may be define randomization schemes for randomly or semi-randomly assigning subjects into two or more groups. Randomization schemes may be pre-programmed and presented for selection, or may be user-generated. Examples of randomization schemes include Simple Randomization Schemes (e.g., Wei's Urn and Permutated Block Design, etc.), Stratified Randomization Schemes (e.g., Simple Stratification, Complex Logical Stratification, Complex Partitioned Stratification, etc.), Grouped Dynamic Randomization, Hierarchical Dynamic Randomization, Dynamically Efficient Randomization, Hybrid Randomization Schemes, and User-Defined Randomization Schemes, among other possibilities.

At step 140, p-values for characteristics of interest may be determined. The p-values may be determined by carrying out a simulation which randomizes the study population into trial groups using the information provided at steps 110-130.

For example, based on the population information provided at steps 110-120 a simulated population having covariates of interest (distributed according to the covariate distribution 218 of FIG. 2A) may be generated. This may involve, for example, generating datasets representative of the characteristics of interest and their dispersal throughout the simulated population. For example, simulated subjects may be generated and may be randomly assigned characteristics based on the covariate distribution 218. These simulated datasets may represent independent or dependent characteristics (e.g., covariates) of events, entities, or individuals.

Thus, a population of simulated subjects may be generated. Each of the simulated subjects may have a covariate profile indicating the presence and/or extent of covariates of interest which are associated with an individual simulated subject. Using the randomization schemes defined by the randomization models selected at step 130 and/or the cohort sizes provided in step 110, the simulated population may be divided into simulated cohorts. Each simulated cohort may include subgroups defined by one or more covariates of interest.

Multiple simulated cohorts may be generated for a single randomization scheme and/or requested cohort size. Each combination of randomization scheme and/or cohort size may be associated with at least one cohort. Accordingly, the simulated cohorts may serve as test vehicles for the randomization scheme and/or cohort size that defines the simulated cohort.

The simulated cohorts may be compared across different statistical considerations (e.g., single- vs. multi-variable p-values, cutoffs for those p-values, normality criteria, etc.) and across the above-noted covariates of interest (which may be partitioned into sub-intervals, sub-categories, and sub-groups). Using the statistical parameters, each simulated cohort may become a subtest for a particular cohort size and randomization scheme to be tested.

P-values may be determined for the covariates of each subgroup, trial group, and/or simulated cohort. For example, if there are 24 covariate partitions of interest, then each simulated cohort may generate 24 p-values. In the case of each covariate, the p-value for the covariate may represent the probability that the outcome of the study (e.g., the dependent variable) would not be substantially affected by the presence of the covariate. For example, a low p-value (e.g., 0.03) indicates that the covariate plays a relatively large role in determining the outcome of the trial, as compared to a covariate with a relatively high p-value (e.g., 0.25). A “low” p-value may be a p-value which is below a threshold indicating that the covariate has significance in affecting the dependent variable, such as 0.05 or 0.10. A “high” p-value may be a p-value above such a threshold.

In one embodiment, the most significant (i.e., smallest) p-value for each cohort may be taken to represent that particular simulated cohort. Furthermore, multivariate (combined) p-values may be searched and used as a representative p-value for the cohort. The process of finding the most significant p-value may be repeated for every simulated cohort modeled. A larger number of modeled cohorts may provide greater resolution in the output results as well as more stable estimates of the respective randomization schemes score. In a preferred embodiment, at least 100 modeled cohorts per randomization scheme and cohort-size being scored may be used.

At step 150, a risk of covariate imbalances may be calculated using the p-values calculated at step 140. According to one embodiment, the above-noted collection of selected most-significant p-values (e.g., one for each simulated cohort) may be sorted from the most significant (smallest) to the least significant (largest). The proportion that are less than or equal to a cutoff p-value, which may be defined by a predetermined threshold, may be used as the risk score for the particular randomization scheme and cohort-size tested by the simulated cohorts. Thus, the score represents the risk of a significant covariate imbalance that a particular randomization scheme and cohort-size have for a trial across the sub-groups of clinical interest. Such a risk score, applied across multiple randomization schemes and cohort-sizes, allows the randomization schemes and cohort sizes to be compared, not only across the same simulated subject population, but across clinically significant subgroups.

The randomization scoring algorithms may account for variables including (but not limited to) a number of cohorts in the study population, cohort size, number and type of sites from which the study population may be drawn, continuous-type covariates, discrete-type covariates, and dependent-type covariates. The algorithms may further account for preferences (e.g., researcher preferences), such as cohort size, the number of covariates considered, and acceptable cutoff risk(s) for comparability.

In addition to the above-noted risk score, an at-risk score and an efficiency score may also be generated. These scores may be used to evaluate situations when a given subgroup may have too few subjects to be at risk for a significant covariate imbalance. The at-risk score may measure the proportion of the covariate-of-interest subgroups that have sufficient subjects to even theoretically achieve a p-value as significant as the cutoff p-value. The efficiency score measures the proportional impact of the randomization scheme on lowering the covariate imbalance risk amongst only the covariate-of-interest subgroups sufficiently large enough to have a p-value as significant as the cutoff p-value. At smaller cohort-sizes, the impact of the randomization scheme on reducing covariate imbalances may limited. At larger cohort-sizes, a larger proportion of the sub-groups of clinical interest to be tested may have sufficient numbers to be at risk for a significant covariate imbalance. In this manner, the at-risk and efficiency scores allow the granularity of sub-testing to be studied. The at-risk and efficiency scores may further allow the an assessment of the impact of the subgroups to be tested to be made.

At step 160, one or more randomization models associated with a reduced risk of covariate imbalance may be identified. For example, one or more graphs and/or tables may be presented showing the risk of covariate imbalances, as calculated at step 150, among different randomization models. The randomization models with the smallest risk score may represent the randomization model with the lowest probability of creating trial groups having covariate imbalances.

Optionally, at step 170, trial characteristics that are associated with a reduced risk of covariate imbalances may be identified. For example a preferred cohort size, or number or distribution of trial sites may be associated with a reduced risk of covariate imbalances, as reflected in one or more graphs or tables presented to in a manner similar to that of step 160.

Steps 140-170 may be repeated for further randomization schemes and cohort sizes, to allow the risk of covariate imbalances to be further evaluated.

At step 180, a trial population may be selected based on the randomization models identified at step 160 and/or the trial characteristics identified at step 170. For example, data relating to a population available for study may be input into an electronic device. The electronic device may use randomization schemes, cohort sizes, and/or trial characteristics identified at steps 160-170 to randomize the trial population into trial groups.

Thus, using the method described in steps 110-180, a study population may be selected in accordance with parameters that are most likely to reduce the risk of covariate imbalances among trial groups. An example of a series of interfaces that embody steps 110-180 are provided in FIGS. 2B-8C. A step-by-step description of these interfaces is provided below.

### Exemplary Interfaces

FIGS. 2B-2I depict exemplary interfaces for providing population information, as described in steps 110-120, above.

In the interface 230 of FIG. 2B, baseline data for the population which is the subject of the trial may be entered. For example, the interface 230 may include an input 232 for entering the cohort size (i.e., the number of subjects in each cohort) to be applied to the population during the trial. Furthermore, an input 234 may be provided for entering a number of trial sites, and the proportion of observations to the collected from each trial site.

Upon entering baseline data into the interface 230, a predictor interface 240 may be presented, as shown in FIG. 2C. The predictor interface may include an input 242 for entering information about covariates which may be of interest in the trial. As shown in FIG. 2C, the presence of the condition sepsis (i.e., a severe response to bacteria or other germs) is considered to be a relevant covariate in the design of this particular study.

The presence of sepsis is considered to be a categorical predictor (or categorical covariates), because the presence of sepsis is a discrete or boolean condition. That is, sepsis may either be present in a subject, or not present in a subject. Categorical predictors need not necessarily be divided into only two discrete possibilities or subcategories, but rather may include several subcategories which may describe a condition of the subject in a discrete manner. For example, hair color might be a categorical predictor having subcategories of “brown,” “blonde,” “black,” etc.

If a user chooses to add a new categorical predictor in the predictor interface 240, a subcategory dialog 250 may be presented for providing details about each of the subcategories that may be applicable to the categorical covariate of interest. For example, a name input 252 may be provided for entering a name of a subcategory of the categorical covariate of interest (e.g., “Sepsis” or “No Sepsis”). Furthermore, a distribution input 254 may be provided for specifying a distribution of the categorical covariate among the population.

In some cases, the distribution of a covariate among a population may not be even, but rather may be dependent on other factors (e.g., men are more at risk for certain conditions than women, and vice versa). Accordingly, the population may be divided into subgroups, and each subgroup may be assigned a different distribution for a particular covariate. Alternatively, dependency information may be specified, such as a conditional probability, that allows the distribution of the covariate to be derived from the presence or absence of other conditions or covariates.

In the example shown in FIG. 2D, there is an estimated 45% chance that a patient from the particular population or subpopulation under consideration has sepsis. Upon entering this information, an exclusion dialog 260 may be presented for entering covariate exclusion information, as shown in FIG. 2E.

The presence (or absence) of a particular covariate may cause a subject to be excluded from a study. The probability of a subject being excluded from the study due to the presence of a particular covariate may be entered into a probability input 262 on the exclusion dialog 260. The probability may represent, for example, the probability that a subject develops a condition during the course of the study and moves from a non-excluded subgroup into an excluded subgroup.

Different types of exclusions may be accounted for in the exclusion dialog 260. For example, Type 1 Exclusions relate to the probability that the subject's covariate characteristics will exclude the subject from entering or continuing in the trial. An example is a newborn whose gestational age is mistakenly identified as 25 & 0/7 weeks, but who really only is 23 & 5/7 weeks excluding the baby from a trial regarding 24- to 26-week gestation premature babies. Another example would be an adult who is too ill to receive the treatment or intervention being studied. Type 2 Exclusions relate to subjects that enter the study but experience a change in their characteristics that exclude them from the study even though they may have already received the intervention or treatment. Examples include a patient who is diagnosed with another significant morbidity, who undergoes an off-study treatment or therapy, who experiences mortality from a distinct cause, or who drops out of the study.

Type 3 Exclusions concern the likelihood that a subject's categoric characteristic switches during the trial from one subcategory (subpredictor) to another. An example is a subject who initially is not septic, but becomes so during the trial. In this case, the exclusion dialog may further include a “switch target” 264, which identifies a subcategory to which the subject should be switched if the subject develops a particular condition. For example, in the exclusion dialog 260, the subject is initially in the non-septic category. If the subject develops sepsis, then the switch target 264 indicates that the subject should be moved into the septic category.

Once the requisite information is entered into the categorical predictor dialogs as shown in FIGS. 2B-2E, a summary dialog 270 may be displayed, as shown in FIG. 2F. The summary dialog 270 may display details regarding the defined subcategories, probability of a given subject falling into each subcategory, types of exclusions, etc.

In addition to categorical predictors such as sepsis, interval predictors (or interval covariates) may also be used in the trial design. An interval predictor is a predictor which may vary in a continuous manner, such as height or weight.

Interval predictors may be entered into an interval dialog 280, as shown in FIG. 2G. The interval predictor dialog may provide an input 282 for entering a description of the interval in question. Furthermore, a default interval information input 284 for describing details of the interval, such as the beginning and end of the interval, distribution of subjects within the interval, etc. may be provided. A list and/or range of subintervals may be defined in an subinterval dialog 286.

In order to specify the distribution of subjects within the interval, a number of distribution models may be used. Accordingly, a distribution model dialog 290 may be displayed for an interval predictor, as shown in FIG. 2H. The interval predictor that is the subject of the distribution model may be displayed and/or selected in a predictor interval input 291. A list of distribution functions which may be applied to the interval predictor may be displayed in an interval distribution list 292. The distribution of the interval covariate amongst a population may be determined based on preexisting information such as published studies, surveys, or censuses, or may be determined based on simulations or other estimates of covariate distribution, among other possibilities.

Once a distribution model is selected in the distribution model dialog 290, details related to the selected distribution may be entered into a distribution detail dialog 295 as shown in FIG. 2I. For example, details about distribution parameters specific to the particular distribution may be entered into an input 296. Based on the input parameters, representative distribution curves 297 may be generated and displayed that provide detailed information about how the selected parameters will distribute the interval covariate among the population.

In some cases, after two or more covariates have been entered, it may be desirable to assign the covariates to dependency groups. Any given covariate may have multiple effects on other characteristics or outcomes. Non-medical examples of such dependency include the socioeconomic status of a child on different predictors of income level in adulthood. As a consequence, there are situations when it is beneficial to group predictors into dependent risk levels, or risk groups. For example, “High Risk,” “Normal Risk,” and “Low Risk” may be used as dependency groups. This allows predictors or subpredictors and exclusion percentages to be customized across several risk levels.

In order to define dependency groups, a name for the dependency group may first be identified. Within the named dependency group, multiple strata may be created. For strata, individual predictors (e.g., one or more of the categorical and interval covariates previously entered in the interfaces described above) may be selected. The parameters defining the distributions of these predictors may be modified according to their particular risk stratum.

In one example, a subject with the condition cholestasis may be at high risk for developing sepsis and/or jaundice. Sepsis and/or jaundice may have previously been added for consideration as predictors in the interfaces described above. A user may create a dependency group named “cholestatic” and add strata corresponding to the sepsis and jaundice predictors to the cholestatic dependency group. The distribution of the sepsis and jaundice predictors may be modified for subjects within this dependency group (i.e., subjects with cholestasis) based on the increased chance of a cholestatic subject having sepsis and jaundice. This dependency information may be taken into account when simulated subjects are generated for the simulated population.

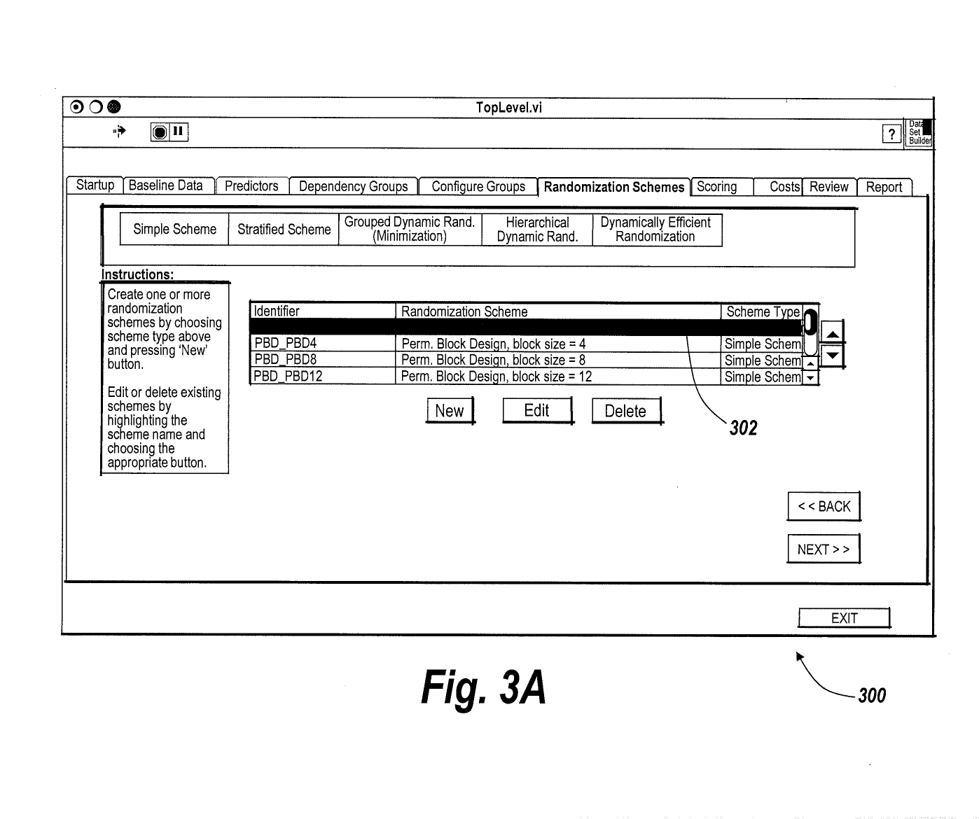

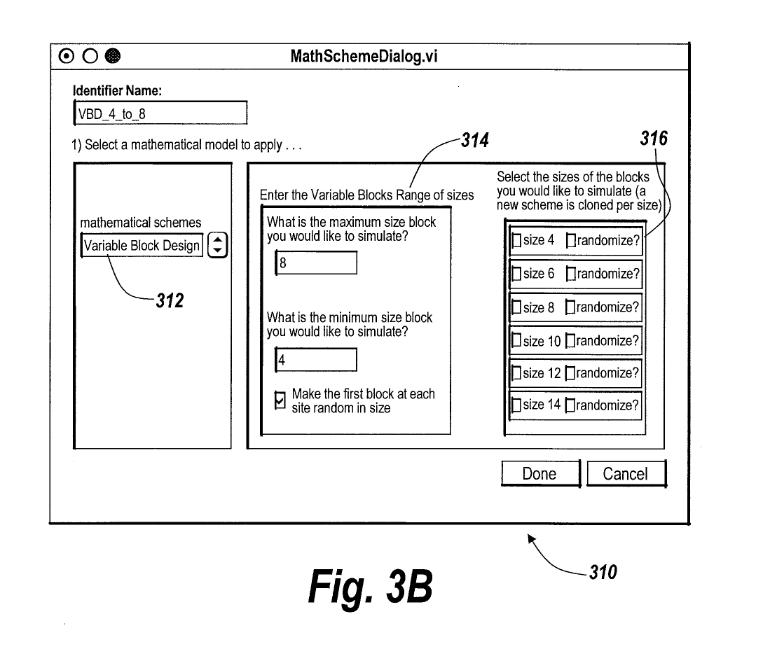

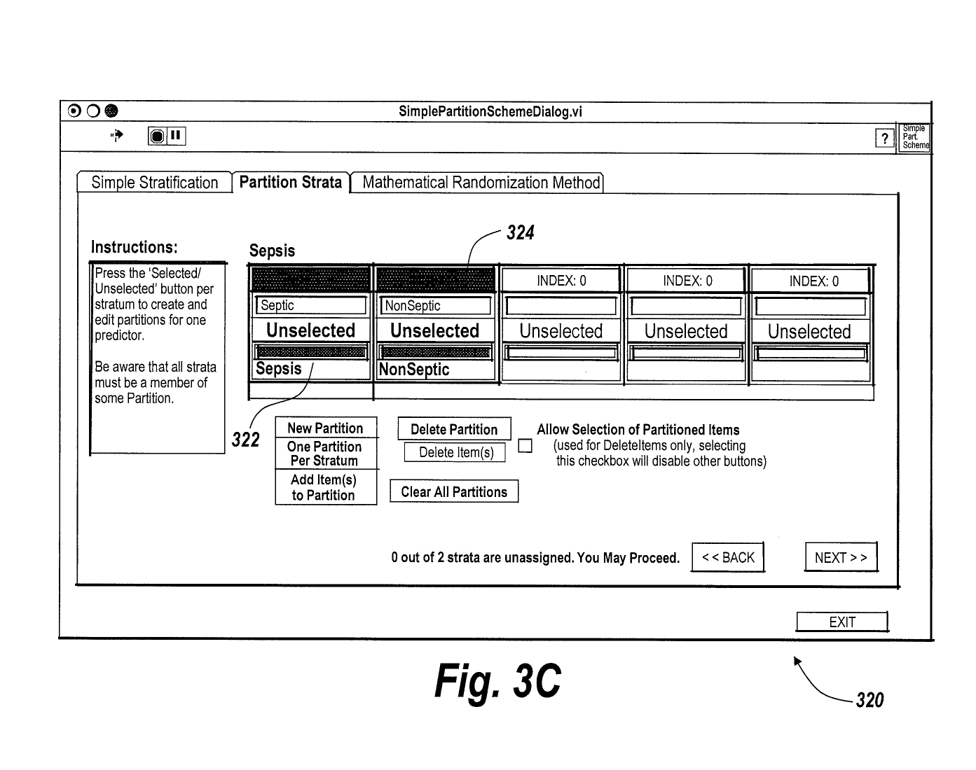

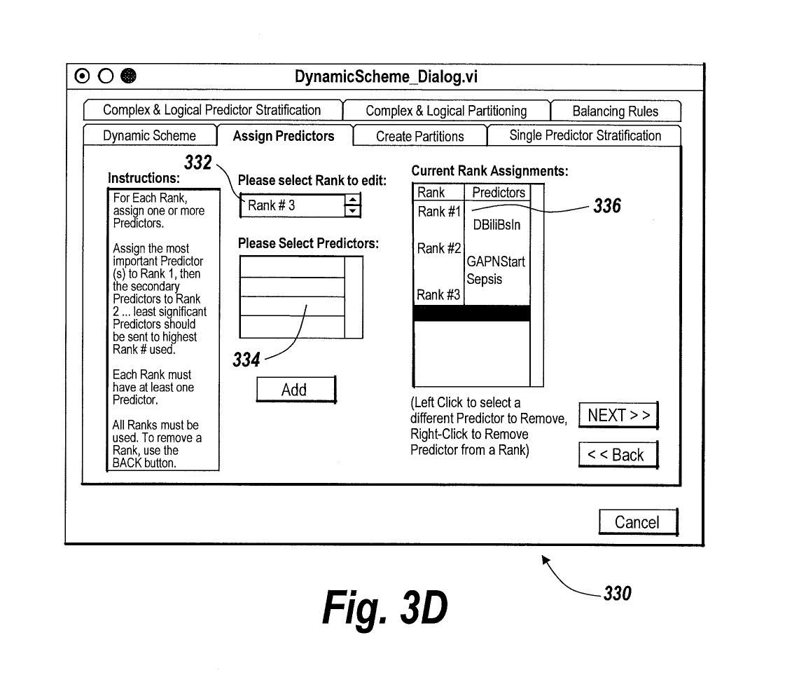

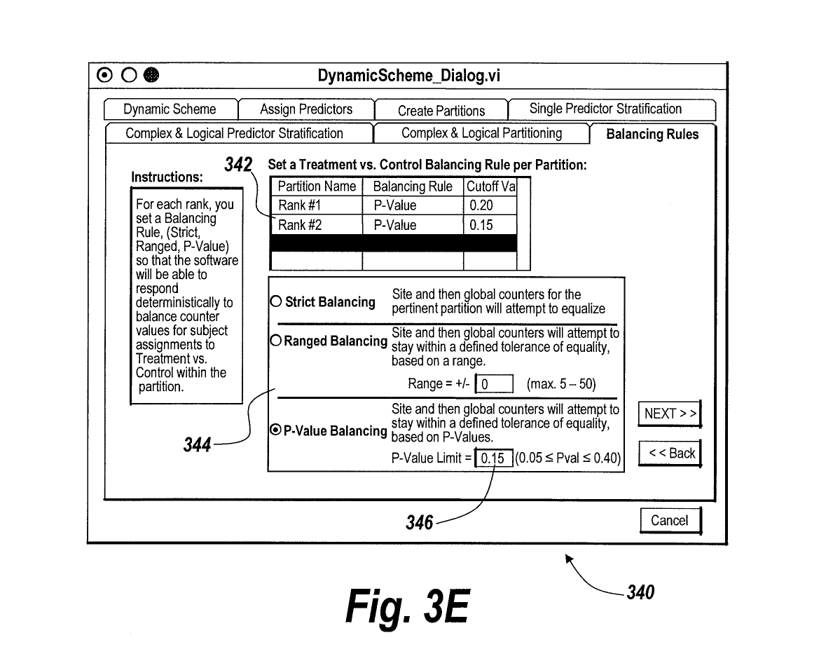

After the population information and covariate information has been entered into the interfaces as shown in FIGS. 2B-2I, one or more randomization schemes may be selected for evaluation. FIGS. 3A-3E depict exemplary interfaces for providing information regarding randomization schemes according to exemplary embodiments.

A randomization interface 300 may be provided for inputting one or more randomization schemes of interest for evaluation. An input list 302 may be provided in the interface 300 for adding or selecting randomization schemes for testing. The randomization schemes may include different types of randomization schemes, including (but not limited to) simple randomization schemes, stratified randomization schemes, grouped dynamic randomization schemes, hierarchical dynamic randomization schemes, and dynamically efficient randomization schemes. Within each type of randomization scheme, specific instances of randomization schemes may be provided. One of ordinary skill in the art will recognize that the randomization schemes of FIG. 3A are exemplary only, and that any suitable randomization scheme may be used.

Upon selecting a randomization scheme for evaluation, a dialog 310 may be provided for entering details regarding parameters to be applied to the randomization scheme, as shown in FIG. 3B. The dialog 310 may include an input 310 for selecting a mathematical model to apply to the randomization scheme, where the mathematical model describes the behavior of the randomization scheme and the underlying statistics involved. A second input 314 may be provided for selecting a range of size blocks to be simulated, if the randomization scheme utilizes variable-sized randomization blocks. Alternatively or in addition, a third interface 316 may be provided for selecting the particular sizes for blocks to be tested.

After providing the details of the randomization scheme, partitions of interest relating to the previously-defined predictors or covariates may be selected, as shown in the interface 320 of FIG. 3C. For example, the exemplary interface 320 provides two partitions of interest for the covariate “sepsis.” The first partition 322 provides a partition for subjects who have sepsis, while a second partition 324 provides a partition for subjects who are non-septic. When the subjects are randomized based on strata, the partitions defined in interface 320 may be used to provide the groupings into which the subjects will be randomized.

Upon entering partitions for one or more of the covariates, an interface 330 may be presented for defining ranks of predictors. The most important predictors may be assigned a first rank, while less important predictors are assigned a second rank, and so on. In randomizing the subjects into groups, the ranks may be taken into account in order to establish a preference for allocating subjects based on higher-ranked covariates. By testing different ranking schemes, different techniques of allocating randomization capital can be evaluated.

The interface 330 may include a rank identification input 332 for selecting a rank to edit. Upon selecting a rank, predictors or covariates may be assigned to the rank in a predictor input 334. A summary display 336 may depict which predictors have been assigned to which rank.

Subjects assigned to each rank of predictors may be balanced among the predictors according to different balancing rules, depending on the rank of the predictor. A balancing rule may define how the probability of assigning a particular subject to a particular group may vary, depending on how balanced or imbalanced the group is with respect to the covariates within the group. An interface 340, as depicted in FIG. 3E, may therefore be presented for allowing different balancing rules to be selected.

Within the interface, a list 342 of the available ranks may be presented. Upon selecting one of the ranks in the list 342, a set of balancing rules 344 may be provided for assigning a balancing rule to the rank. One of ordinary skill in the art will recognize that multiple different types of balancing rules may be used, and the balancing rules depicted in FIG. 3E are intended to be exemplary only. Within the balancing rules 344, one or more parameters 346 may be presented for fine-tuning the balancing rule.

Balancing rules may allow subjects to be assigned to treatment or control groups based on previous assignments of subjects these groups. That is, one or more counters may be defined, which keep track of treatment assignments as well as control assignments within each partition. For a given rank, this information is used to determine how the counters are to be balanced.

For each subject to be assigned, the covariate balance for a particular partition within the subject's site may be checked. If the treatment and control counters are imbalanced according to the chosen Balancing Rule, the subject may be assigned to a group of the study (e.g., treatment vs. control) that would provide increased balance to that partition's groups. If the treatment and control counters are balanced according to the chosen Balancing Rule, an assessment may be made of the covariate balance for that partition for all of the sites. This may represent the global balance across the trial for that specific partition.

If the global (across-all-sites) treatment and control counters are imbalanced according to the chosen Balancing Rule, the subject may be assigned to a group within the study (e.g., treatment vs. control) that would provide increased balance to the groups globally. If the global treatment and control counters are balanced according to the chosen Balancing Rule, an assessment may be made of the covariate balance for the next rank, as described above. If there are no further ranks, the subject may be randomly assigned to a study group.

Examples of Balancing Rules include (but are not limited to) Strict, Range, and P-value. In Strict Balancing, an assessment may be made of the covariate balance for a partition of interest based upon the absolute totals for the treatment and control counters (first site and then globally as needed). The subject may be assigned to a study group that would provide increased balance to the respective groups. If the treatment and control counters are balanced according to Strict balancing, an assessment may be made of the covariate balance for the next rank of covariates. If there are no further ranks, the subject may be randomly assigned to a study group.

In Ranged Balancing, a determination of the covariate balance for a partition of interest may be made based upon the whether the difference between the absolute totals for the treatment and control counters (first site and then globally as needed) fall within a specified range. The range may be, for example, user-defined or programmatically selected. In one embodiment, the range may be between +/−1 to 50. In a preferred embodiment, the range is between 1 and 5. Larger ranges may be used, but such larger ranges may be more suitable for large trials, and may be better handled by other methods such as p-value balancing.

If a subject assignment to a particular study group would cause the respective totals to exceed the range limit, the subject may be assigned to a study group that would provide increased balance to the respective groups. If the treatment and control counters would be within the specified range for either assignment, the covariate balance for the next rank may be evaluated. If there are no further ranks, subject may be randomly assigned to a study group.

In P-value Balancing, a covariate balance for a particular partition of interest may be determined based upon the whether the p-value between the absolute totals for the treatment and control counters (first site and then globally as needed) remain above a specified limit. If the p-value falls below the limit, the covariates may be considered to be imbalanced. The p-value limit may be User-defined or programmatically defined. For example, the p-value limit may be between 0.05 and 0.40 and, in a preferred embodiment, between 0.05 and 0.10. If the subject assignment to a particular study group would cause the respective totals to fall below the p-value limit, the subject may be assigned to the study group that would provide increased balance to the respective groups. If the treatment and control counters would be within the specified p-value limit for either assignment, an assessment may be made of the covariate balance for the next rank. If there are no further ranks, the subject may be randomly assigned to a study group.

Larger p-value limits, like smaller ranges, may allow for a smaller proportion of subjects to pass through to the next rank. Accordingly, the risk of significant covariate imbalances may be reduced by customizing how imbalances are managed under randomization. Tighter control of higher-ranked covariates may be accomplished selecting p-values that increase in tolerance (lower p-values) as the ranked predictors decrease in importance. For instance, a p-value level of 0.20 may be chosen for the most important rank, and a p-value of 0.15 for the lower ranks.

The Balancing Rules may be used to minimize covariate imbalances in order of importance. However, significant randomization capital may be spent on maintaining covariate balance for the highest-ranked predictor across the subject's site and then globally. This may be especially true for tight control on a covariate, e.g., strict balancing, relatively tight ranged balancing (range=+/−1-3, larger ranges for larger trials), and larger p-value (≧0.20) for p-value balancing. In other words, few subjects may actually be assigned on the basis of the lower-ranked covariates if the higher-ranked predictors consume the majority of the assignments.

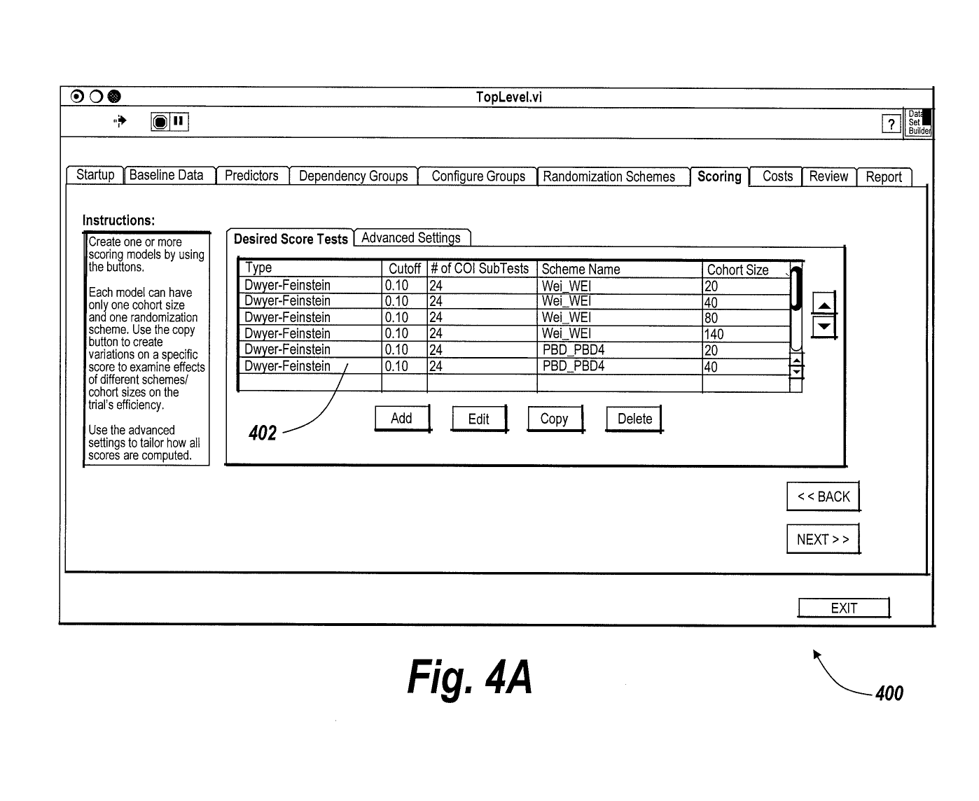

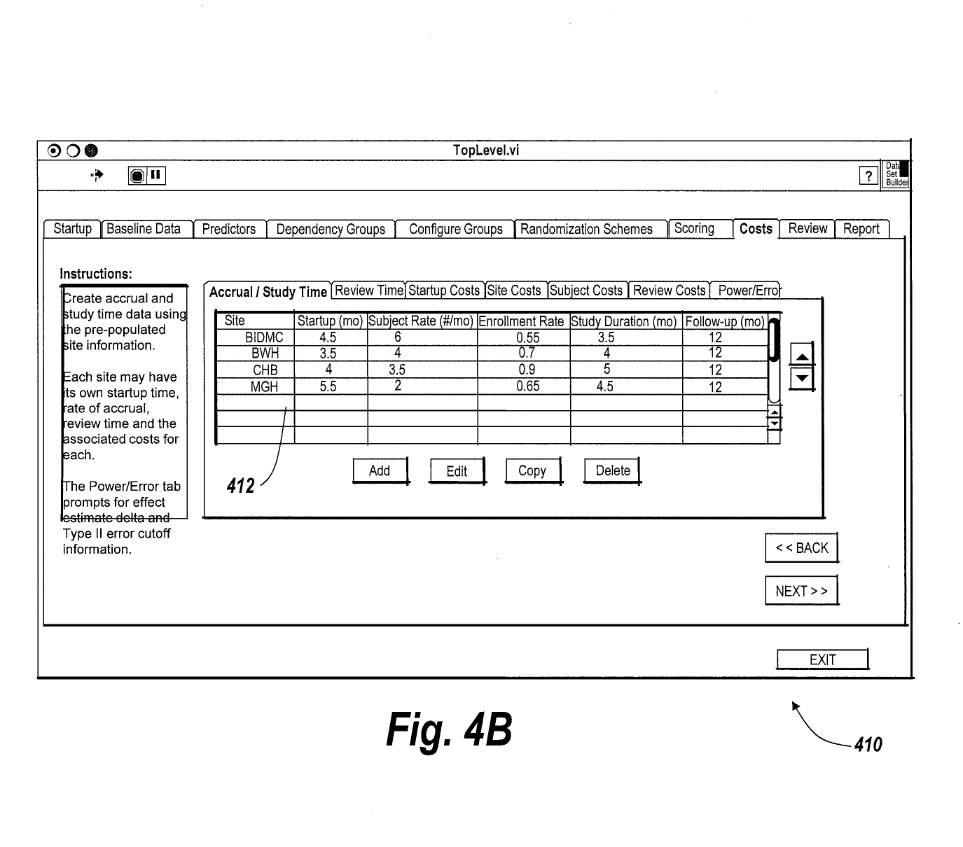

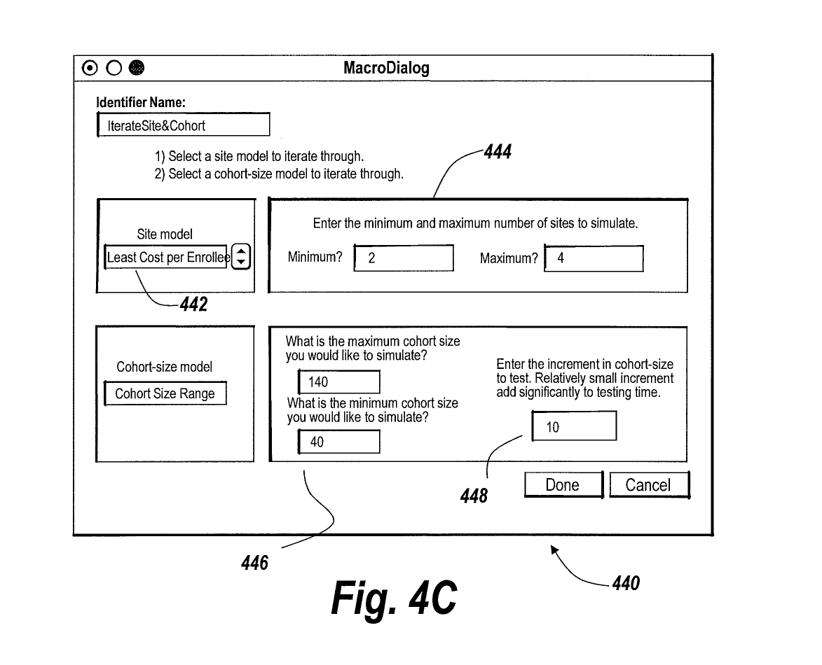

Once the randomization schemes and balancing rules are defined, different risk scoring algorithms may be presented and selected for evaluation. FIG. 4A depicts an exemplary interface 400 for providing information related to estimated risk scores for predicting the risk of a covariate imbalance. The information related to the risk scores may be presented, for example, in a list 402 of available risk scoring algorithms (such as the risk scoring algorithms described above with respect to step 150 of FIG. 1).

With the above information related to scoring the randomization scheme(s) having been entered, an option may be presented to track direct and theoretical costs. For example, FIG. 4B shows an exemplary interface 420 for providing information concerning study startup, duration, and review time as well as the direct costs associated with each. Theoretical costs, such as statistical power, may also be entered into the interface 420. The information related to time, direct costs, and other statistical risks may be presented, for example, in a list 422 regarding each of the individual trial sites (such as the site information described above with respect to step 234 of FIG. 2B).

With the optional information related to direct and theoretical costs having been entered, an option may be presented to enter macro parameters to iterate through. For instance, FIG. 4C shows an exemplary interface 440 for providing information concerning the parameters for iterating through the range of sites to be tested. A site model, such as all sites or least cost per enrollee, may also be selected in the interface 442. The information related to the minimum and maximum number of sites may be entered into the interface 444. To model a cohort-size range, the minimum and maximum sizes are entered in interface 446. The increment in cohort size to iterate through the cohort-size range may be presented in interface 448.

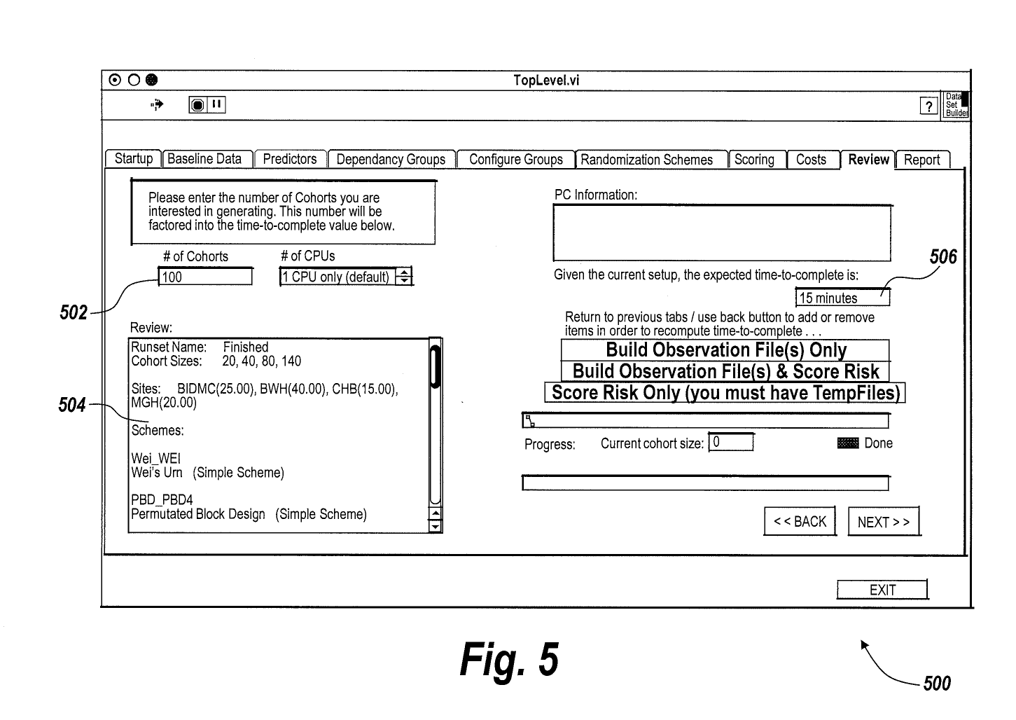

After the above-noted information relating to the study population, randomization schemes, and risk scoring algorithms has been entered, a summary interface may be displayed for reviewing the choices made to this point. For example, FIG. 5 depicts an exemplary summary interface 500 summarizing information entered in FIGS. 2B-4.

In the summary interface 500, an input 502 may be provided for identifying the number of cohorts to be evaluated. In a preferred embodiment, the number of cohorts used is at least 100, in order to provide sufficient results for comparison. A summary page 504 may be provided summarizing the population information, randomization schemes, and/or risk scoring algorithms to be used in the simulation. Using the information present in the input 502, the summary page 504, and information regarding the computational speed and/or power of the electronic device or devices on which the simulation is to be run, an estimated amount of time to complete the simulation and an evaluation of the randomization schemes may be provided in a window 506.

After the information in the summary interface 500 is reviewed and accepted, a simulation may be run testing the efficacy of the randomization schemes in allocating subjects to groups without incurring significant covariate imbalances. One or more summary graphs or tables may be presented depicting the results of the simulation.

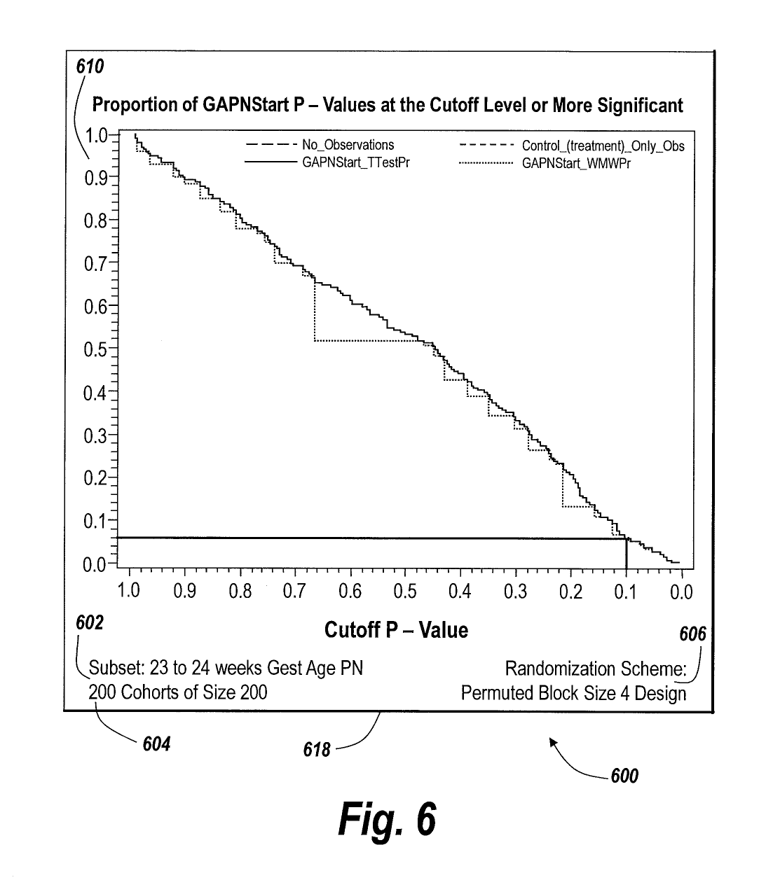

For example, FIG. 6 is an exemplary output graph 600 showing the proportion of covariate P-values that are at or above a threshold level for significance for a particular covariate (in this case, a parental nutrition covariate). A subgroup 602 of the population is depicted in the graph 600. Cohort information 604 and a randomization scheme under evaluation 606 is described for the particular combination of parameters under consideration in the graph. The X-axis 608 depicts a cutoff p-value (representing, for example, a threshold value for which the covariate may be considered to have significance in affecting the outcome under study), while the Y-axis 610 depicts the proportion of p-values that were at or below the cutoff p-value in the simulation. The data 612 from the simulation is plotted on the graph 600.

In the example shown in FIG. 6, 200 cohorts, each of size 200, were tested. Subjects were randomized in the cohorts using a permuted block randomization scheme, with blocks of size 4. As shown in the graph 600, for example, about 6% of p-values in the simulation were at or below a threshold p-value of 0.1. This value of 6% or 0.06 may represent the risk score for this particular combination of parameters for a cutoff p-value of 0.1.

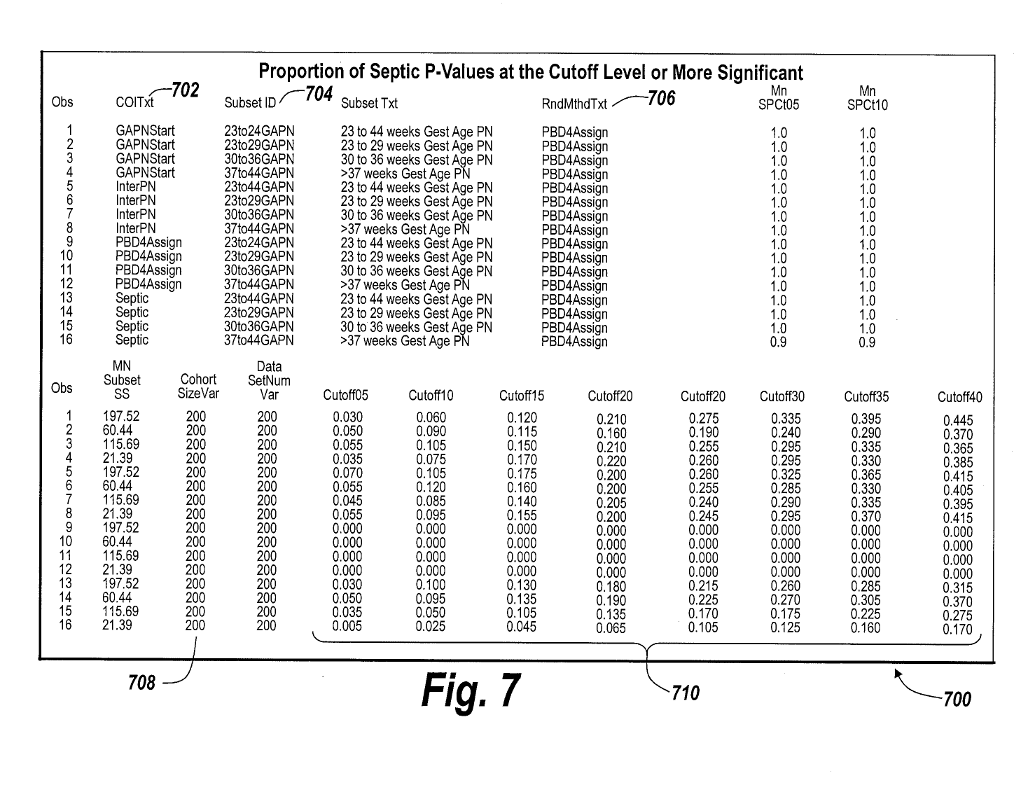

In addition to a graph 600 (or as an alternative), data from the simulation may be presented in tabular form, such as the table 700 of FIG. 7. A number of covariates 702 and subgroups 704 may be presented in the table 700. Randomization methods 706 and cohort sizes 708 tested for each covariate 702 may be presented, along with a risk score 710 for each combination. The risk scores 710 may be presented for different p-value cutoffs, such as 0.05, 0.10, 0.15, etc.

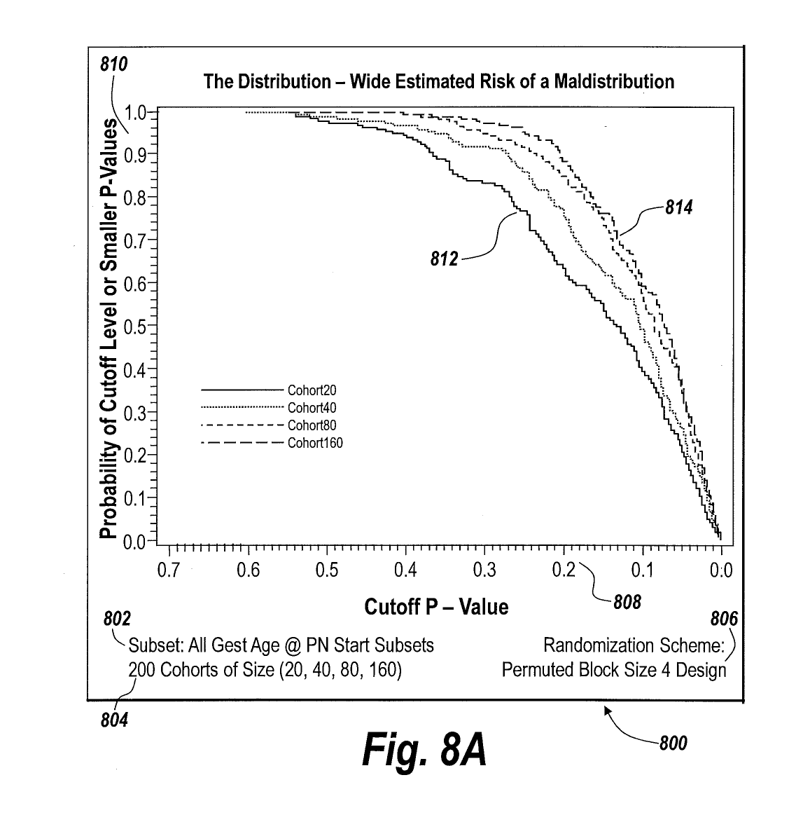

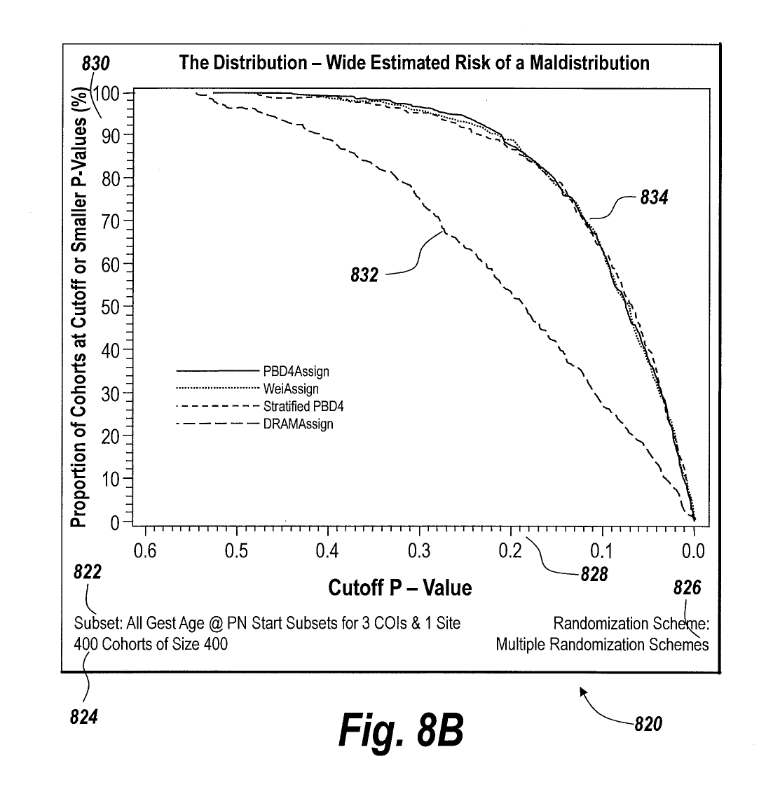

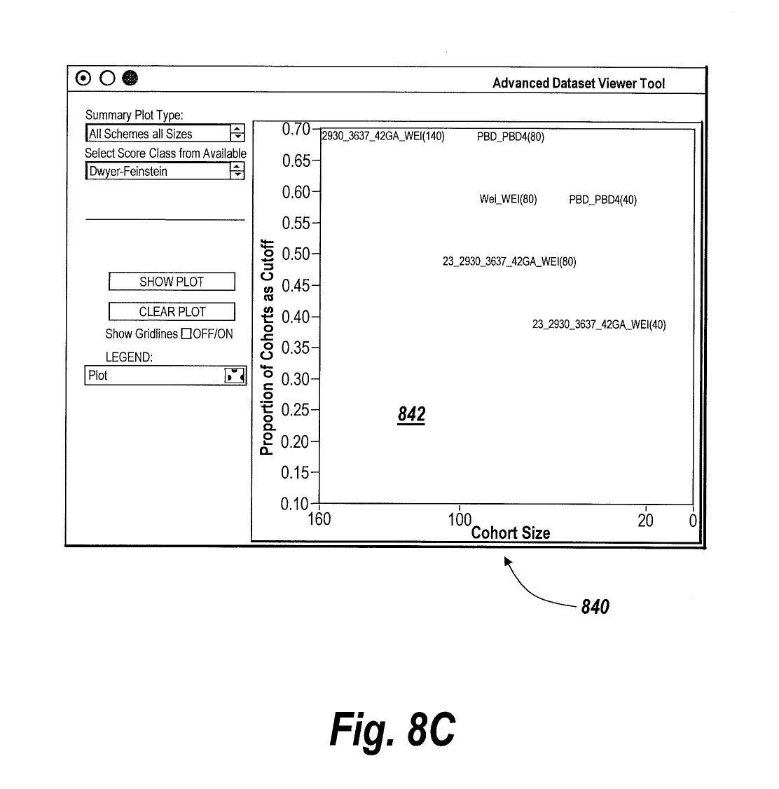

Different randomization schemes and/or cohort sizes may be tested and displayed on the same graph for comparison. For example, FIG. 8A is an exemplary output graph 800 showing the proportion of covariate P-values 810 that are at or above a threshold level for significance 808 among different cohorts 804 subjected to a specified randomization scheme 806, given a particular subgroup of the population 802. As shown in the graph 800, different cohort sizes (20, 40, 80, and 160) have been tested in the simulation.

The graph 800 provides a simple display for comparing the risk score for different cohort sizes. In this example, the line 812 represents the tests for a cohort size of 20. The line 814 represents the tests for a cohort size of 160. As shown in the graph 800, the risk score for the line 812 is consistently lower than the line 814, indicating a lower chance of covariate imbalances if a cohort size of 20 is used as compared to a cohort size of 160. For example, at a cutoff p-value of 0.1, the risk score for the line 812 is approximately 0.4, while the risk score for the line 814 is approximately 0.66. In this way, the effect of different cohort sizes on the risk of covariate imbalances can be tested and compared.

In a similar manner, different randomization schemes may be tested and graphed. For example, FIG. 8B is an exemplary output graph 820 showing the proportion of covariate P-values 830 that are at or above a threshold level for significance 828 among cohorts 824 subjected to a different randomization schemes 826 for particular subgroups 822. As shown in the graph 820, the line representing a dynamic random assignment randomization scheme 832 indicates a consistently lower risk of covariate imbalances than a stratified randomization scheme 834.

The simulation results may be presented in a tabular form that summarizes for each randomization model tested the following: the number of subjects, the number of sites, the proportion of covariate P-values that are at or above a threshold level for significance (the distribution wide estimated risk), the at-risk proportion of the study population, the efficiency in reducing the covariate imbalance risk, the overall study duration including startup and review time, the overall trial cost, and the statistical power, or Type II error. For each trial site, study startup, duration, and review time as well as the direct costs associated with each to recruit to projected number of subjects for that site under the randomization model may be presented.

In addition to depicting the results of the simulation in graphical or tabular format, an output plot of the results may be generated and displayed. For example, FIG. 8C is an exemplary display screen 840 showing an output plot 842 depicting a proportion of cohorts having P-values that are at or above a threshold as compared to the size of the cohorts (e.g., 140 vs. 80 vs. 40) for different randomization schemes (e.g., Stratified by Gestational Age Wei vs. Simple Wei vs. Permutated Block 4). The lower proportion of cohorts that are at or below the cutoff, the lower the risk of covariate imbalances. For example, the plot 842 shows that a preferred design regarding covariate imbalances would utilize a cohort-size of 40 and Wei's Urn across stratified gestational ages (e.g., 23 to 29 weeks, 30 to 36 weeks, and greater than 37 weeks).

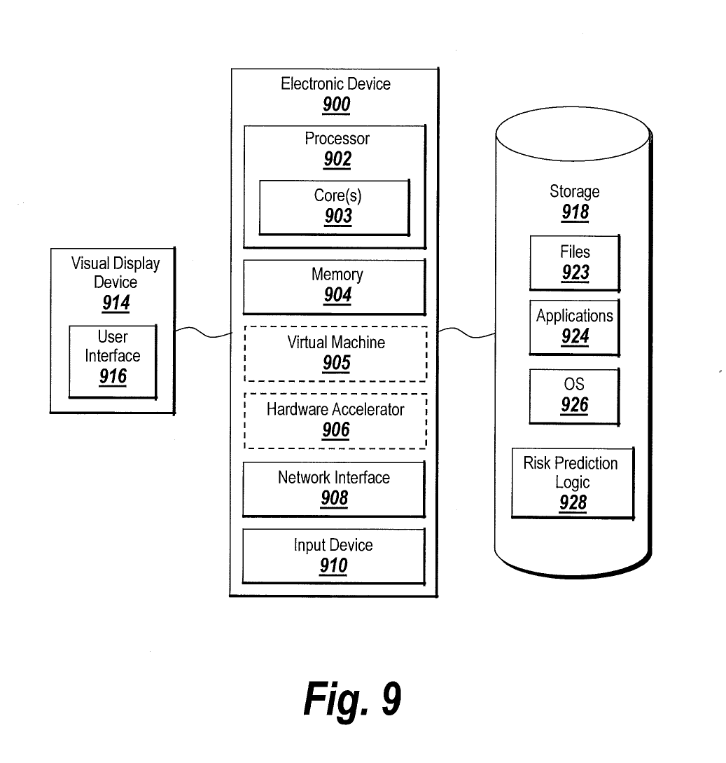

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 9 depicts an example of an electronic device 900 that may be suitable for use with one or more acts disclosed herein.

The electronic device 900 may take many forms, including but not limited to a computer, workstation, server, network computer, quantum computer, optical computer, Internet appliance, mobile device, a pager, a tablet computer, a smart sensor, application specific processing device, etc.

The electronic device 900 is illustrative and may take other forms. For example, an alternative implementation of the electronic device 900 may have fewer components, more components, or components that are in a configuration that differs from the configuration of FIG. 9. The components of FIG. 9 and/or other figures described herein may be implemented using hardware based logic, software based logic and/or logic that is a combination of hardware and software based logic (e.g., hybrid logic); therefore, components illustrated in FIG. 6 and/or other figures are not limited to a specific type of logic.

The processor 902 may include hardware based logic or a combination of hardware based logic and software to execute instructions on behalf of the electronic device 900. The processor 902 may include logic that may interpret, execute, and/or otherwise process information contained in, for example, the memory 904. The information may include computer-executable instructions and/or data that may implement one or more embodiments of the invention. The processor 902 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 603. Moreover, the processor 602 may include a system-on-chip (SoC) or system-in-package (SiP).

The electronic device 900 may include one or more tangible non-transitory computer-readable storage media for storing one or more computer-executable instructions or software that may implement one or more embodiments of the invention. The non-transitory computer-readable storage media may be, for example, the memory 904 or the storage 918. The memory 904 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 900 may include a virtual machine (VM) 905 for executing the instructions loaded in the memory 904. A virtual machine 905 may be provided to handle a process running on multiple processors so that the process may appear to be using only one computing resource rather than multiple computing resources. Virtualization may be employed in the electronic device 900 so that infrastructure and resources in the electronic device may be shared dynamically. Multiple VMs 905 may be resident on a single computing device 900.

A hardware accelerator 906, may be implemented in an ASIC, FPGA, or some other device. The hardware accelerator 906 may be used to reduce the general processing time of the electronic device 900.

The electronic device 900 may include a network interface 908 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 608 may include a built-in network adapter, network interface card, personal computer memory card international association (PCMCIA) network card, card bus network adapter, wireless network adapter, universal serial bus (USB) network adapter, modem or any other device suitable for interfacing the electronic device 900 to any type of network capable of communication and performing the operations described herein.

The electronic device 900 may include one or more input devices 910, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 900 may include other suitable I/O peripherals.

The input devices 910 may allow a user to provide input that is registered on a visual display device 914. A graphical user interface (GUI) 916 may be shown on the display device 914.

A storage device 918 may also be associated with the computer 900. The storage device 918 may be accessible to the processor 902 via an I/O bus. The information may be executed, interpreted, manipulated, and/or otherwise processed by the processor 902. The storage device 918 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 918 may further store applications 924, and the electronic device 900 can be running an operating system (OS) 926. Examples of OS 626 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

Furthermore, the storage 918 may include risk prediction logic 928. The risk prediction logic may include instructions for performing a method that includes steps similar or identical to those of FIG. 1.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

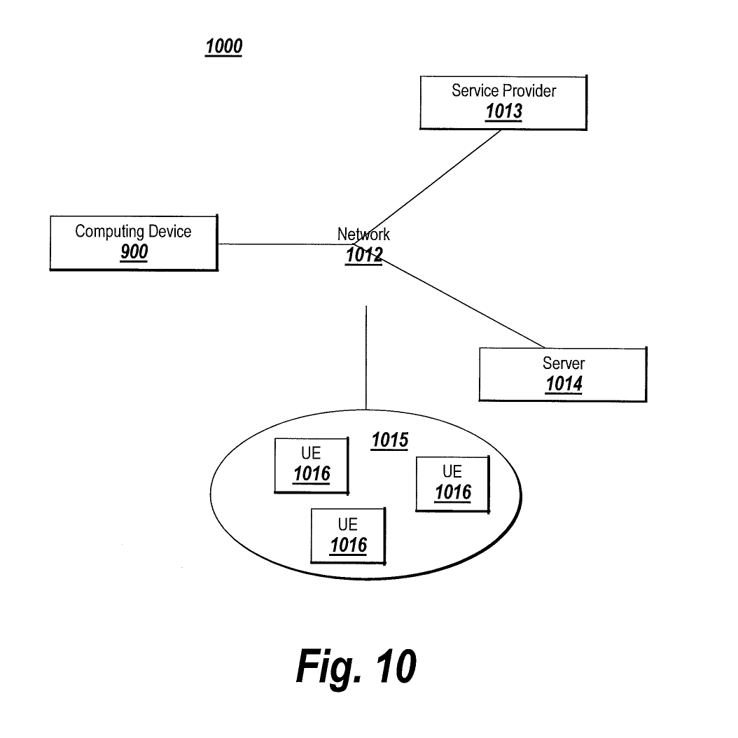

FIG. 10 depicts a network implementation that may implement one or more embodiments of the invention. A system 1000 may include a computing device 900, a network 1012, a service provider 1013, a target environment 1014, and a cluster 1015. The embodiment of FIG. 10 is exemplary, and other embodiments can include more devices, fewer devices, or devices in arrangements that differ from the arrangement of FIG. 10.

The network 1012 may transport data from a source to a destination. Embodiments of the network 1012 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the computing device 900, the service provider 1013, etc.). Data may include digital information or analog information. Data may further be packetized and/or non-packetized.

The network 1012 may be a hardwired network using wired conductors and/or optical fibers and/or may be a wireless network using free-space optical, radio frequency (RF), and/or acoustic transmission paths. In one implementation, the network 1012 may be a substantially open public network, such as the Internet. In another implementation, the network 1012 may be a more restricted network, such as a corporate virtual network. The network 1012 may include Internet, intranet, Local Area Network (LAN), Wide Area Network (WAN), Metropolitan Area Network (MAN), wireless network (e.g., using IEEE 802.11), or other type of network The network 1012 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

The service provider 1013 may include a device that makes a service available to another device. For example, the service provider 1013 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

The server 1014 may include a device that receives information over the network 1012. For example, the server 1014 may be a device that receives user input from the computer 900.

The cluster 1015 may include a number of units of execution (UEs) 1016 and may perform processing on behalf of the computer 900 and/or another device, such as the service provider 1013 or server 1014. For example, the cluster 1015 may perform parallel processing on an operation received from the computer 900. The cluster 1015 may include UEs 1016 that reside on a single device or chip or that reside on a number of devices or chips.

The units of execution (UEs) 1016 may include processing devices that perform operations on behalf of a device, such as a requesting device. A UE may be a microprocessor, field programmable gate array (FPGA), and/or another type of processing device. UE 1016 may include code, such as code for an operating environment. For example, a UE may run a portion of an operating environment that pertains to parallel processing activities. The service provider 713 may operate the cluster 1015 and may provide interactive optimization capabilities to the computer 900 on a subscription basis (e.g., via a web service).

Units of Execution (UEs) may provide remote/distributed processing capabilities for the applications 924. A hardware unit of execution may include a device (e.g., a hardware resource) that may perform and/or participate in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, a hardware unit of execution may include a single processing device that includes multiple cores or a number of processors. A hardware unit of execution may also be a programmable device, such as a field programmable gate array (FPGA), an application specific integrated circuit (ASIC), a digital signal processor (DSP), or other programmable device. Devices used in a hardware unit of execution may be arranged in many different configurations (or topologies), such as a grid, ring, star, or other configuration. A hardware unit of execution may support one or more threads (or processes) when performing processing operations.

A software unit of execution may include a software resource (e.g., a technical computing environment) that may perform and/or participate in one or more parallel programming activities. A software unit of execution may perform and/or participate in one or more parallel programming activities in response to a receipt of a program and/or one or more portions of the program. A software unit of execution may perform and/or participate in different types of parallel programming using one or more hardware units of execution. A software unit of execution may support one or more threads and/or processes when performing processing operations.

The term ‘parallel programming’ may be understood to include multiple types of parallel programming, e.g. task parallel programming, data parallel programming, and stream parallel programming. Parallel programming may include various types of processing that may be distributed across multiple resources (e.g., software units of execution, hardware units of execution, processors, microprocessors, clusters, labs) and may be performed at the same time.

For example, parallel programming may include task parallel programming where a number of tasks may be processed at the same time on a number of software units of execution. In task parallel programming, a task may be processed independently of other tasks executing, for example, at the same time.

Parallel programming may include data parallel programming, where data (e.g., a data set) may be parsed into a number of portions that may be executed in parallel using, for example, software units of execution. In data parallel programming, the software units of execution and/or the data portions may communicate with each other as processing progresses.

Parallel programming may include stream parallel programming (sometimes referred to as pipeline parallel programming). Stream parallel programming may use a number of software units of execution arranged, for example, in series (e.g., a line) where a first software unit of execution may produce a first result that may be fed to a second software unit of execution that may produce a second result given the first result. Stream parallel programming may also include a state where task allocation may be expressed in a directed acyclic graph (DAG) or a cyclic graph.

Other parallel programming techniques may involve some combination of task, data, and/or stream parallel programming techniques alone or with other types of processing techniques to form hybrid-parallel programming techniques.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. For example, the invention may be practiced without the use of an idle period analyzer 160 or without determining whether the system 110 is in an idle period. Thus, non-latency-sensitive requests may be divided into sub-requests and serviced without regard to whether an idle period is in effect. Alternatively, the idle period analyzer 160 could be used without splitting the non-latency-sensitive requests into sub-requests.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

It is intended that the invention not be limited to the particular embodiments disclosed above, but that the invention will include any and all particular embodiments and equivalents falling within the scope of the following appended claims.

1. An electronic-device implemented method comprising:
receiving input characteristics of interest related to a population associated with a plurality of characteristics of interest that independently associate with an outcome of interest in a trial;
receiving a selection of one or more randomization models;
determining p-values for the characteristics of interest;
determining a risk of covariate imbalances for the one or more randomization models based on the determined p-values; and
identifying one of the one or more randomization models that is associated with a reduced risk of covariate imbalances.

2. The method of claim 1, further comprising displaying the risk of covariate imbalances for the one or more randomization models on a display.

3. The method of claim 1, further comprising selecting a population for the trial based on the identified randomization model to thereby allocate randomization capital in the trial to reduce the risk of covariate imbalances for one or more characteristics of the trial

4. The method of claim 1, further comprising receiving dependency information among multiple-level risk subpopulations that have input characteristics of interest related to the population associated with the plurality of characteristics of interest.

5. The method of claim 1, further comprising:
receiving input regarding at least one of the population size, the number of trial sites, and the proportion of subjects at each site to be considered, scored, or tested; and
identifying one of the one or more population sizes, number of trial sites, and proportion of subjects that is associated with a reduced risk of covariate imbalances.

6. The method of claim 5, further comprising receiving a selection of a trial design for the population of interest based on the identified randomization model, population size, and number of sites to thereby randomize efficiently in the trial to reduce the risk of covariate imbalances for one or more characteristics of the trial.

7. The method of claim 1, further comprising defining a macro for searching for the most cost effective randomization model.

8. A non-transitory electronic-device readable medium storing instructions that, when executed by one or more processors, cause the one or more processors to:
receive input characteristics of interest related to a population associated with a plurality of characteristics of interest that independently associate with an outcome of interest in a trial;
receive a selection of one or more randomization models;
determine p-values for the characteristics of interest;
determine a risk of covariate imbalances for the one or more randomization models based on the determined p-values; and
identify one of the one or more randomization models that is associated with a reduced risk of covariate imbalances.

9. The medium of claim 8, further storing instructions for displaying the risk of covariate imbalances for the one or more randomization models on a display.

10. The medium of claim 8, further storing instructions for selecting a population for the trial based on the identified randomization model to thereby allocate randomization capital in the trial to reduce the risk of covariate imbalances for one or more characteristics of the trial

11. The medium of claim 8, further storing instructions for receiving dependency information among multiple-level risk subpopulations that have input characteristics of interest related to the population associated with the plurality of characteristics of interest.

12. The medium of claim 8, further storing instructions for:
receiving input regarding at least one of the population size, the number of trial sites, and the proportion of subjects at each site to be considered, scored, or tested; and
identifying one of the one or more population sizes, number of trial sites, and proportion of subjects that is associated with a reduced risk of covariate imbalances.

13. The medium of claim 12, further storing instructions for receiving a selection of a trial design for the population of interest based on the identified randomization model, population size, and number of sites to thereby randomize efficiently in the trial to reduce the risk of covariate imbalances for one or more characteristics of the trial.

14. A system comprising:
a storage for storing one or more randomization models; and
a processor for:
receiving input characteristics of interest related to a population associated with a plurality of characteristics of interest that independently associate with an outcome of interest in a trial;
receiving a selection of one or more of the randomization models;
determining p-values for the characteristics of interest;
determining a risk of covariate imbalances for the one or more randomization models based on the determined p-values; and
identifying one of the one or more randomization models that is associated with a reduced risk of covariate imbalances.

15. The system of claim 14, wherein the processor is further configured to display the risk of covariate imbalances for the one or more randomization models on a display.

16. The system of claim 14, wherein the processor is further configured to receive a selection a population for the trial based on the identified randomization model to thereby allocate randomization capital in the trial to reduce the risk of covariate imbalances for one or more characteristics of the trial

17. The system of claim 14, wherein the processor is further configured to receive dependency information among multiple-level risk subpopulations that have input characteristics of interest related to the population associated with the plurality of characteristics of interest.

18. The system of claim 14, wherein the processor is further configured to:
receive input regarding at least one of the population size, the number of trial sites, and the proportion of subjects at each site to be considered, scored, or tested; and
identify one of the one or more population sizes, number of trial sites, and proportion of subjects that is associated with a reduced risk of covariate imbalances.

19. The system of claim 18, wherein the processor is further configured to receive a selection of a trial design for the population of interest based on the identified randomization model, population size, and number of sites to thereby randomize efficiently in the trial to reduce the risk of covariate imbalances for one or more characteristics of the trial.

20. A system comprising:
a user device for specifying input characteristics of interest related to a population associated with a plurality of characteristics of interest that independently associate with an outcome of interest in a trial; and
a server for:
receiving a selection of one or more of the randomization models;
determining p-values for the characteristics of interest; and
determining a risk of covariate imbalances for the one or more randomization models based on the determined p-values, wherein
the risk of covariate imbalances is displayed on the user device to allow a user to identify one of the one or more randomization models that is associated with a reduced risk of covariate imbalances.
